(19) United States
(12) Patent Application Publication
(10) Pub. No.: US 2026/0027699 A1
(43) Pub. Date: Jan. 29, 2026

(54) Devices, Systems, and Methods for Adjusting Articulating Wearable Robot Parameters

(71) Applicants: United States Government as Represented by the Department of Veterans Affairs, Washington, DC (US); Northwestern University, Chicago, IL (US); The Board of Trustees of the University of Illinois, Urbana, IL (US)

(72) Inventors: Matthew Major, Chicago, IL (US); Myunghee Kim, Chicago, IL (US)

(21) Appl. No.: 19/282,646

(22) Filed: Jul. 28, 2025

Related U.S. Application Data
(60) Provisional application No. 63/676,011, filed on Jul. 26, 2024.

(51) Int. Cl. B25J 9/00; B25J 9/16

(52) U.S. Cl. CPC B25J 9/0006; B25J 9/1633; B25J 9/1692

(57) ABSTRACT

A system for customizing a wearable robot is disclosed. The system includes at least one human parameter measurement device and a computing device configured to receive feedback from the at least one human parameter measurement device. The computing device is further configured to communicate with the wearable robot to adjust dynamics of the wearable robot. The computing device has at least one processor and memory in communication with the at least one processor. The memory has instructions that, when executed by the at least one processor, cause the at least one processor to apply an optimization algorithm to iteratively adjust the dynamics of the wearable robot. Each iterative adjustment of the dynamics of the wearable robot by the optimization algorithm includes the steps of receiving at least one measurement from the at least one human parameter measurement device and adjusting the dynamics of the wearable robot based on the at least one measurement.

### CROSS-REFERENCE TO RELATED APPLICATIONS

This application claims priority to and the benefit of the filing date of U.S. Provisional Patent Application No. 63/676,011, filed Jul. 26, 2024, the entirety of which is hereby incorporated by reference herein in its entirety.

### FIELD

This disclosure relates to systems for providing personalized prostheses and orthoses/exoskeletons.

### BACKGROUND

A wearable robot is a promising technology for assistance and rehabilitation. However, the practical design of such a device has been challenging. One main challenge is high inter-subject variability, such as variability in biomechanics, which results in various assistance outcomes. Recent studies addressed inter-subject variability by personalizing assistance methods to meet each user's needs. Personalizing wearable robots by incorporating user physiological feedback can improve energy efficiency and comfort. However, many current personalization methods are specific to a particular device and often require reprogramming, making them less accessible.

### SUMMARY

Disclosed herein, in various aspects, is an open-source, device-independent personalization framework that allows for human-in-the-loop optimization. This modular framework includes cost functions and optimization algorithms that use a physiological response to optimize wearable robot parameters. These and other objects and features of the present invention will become more fully apparent from the following description and appended claims, or may be learned by the practice of the invention as set forth hereinafter.

In one aspect, a system for customizing a wearable robot includes at least one human parameter measurement device and a computing device configured to receive feedback from the at least one human parameter measurement device. The computing device is further configured to communicate with the wearable robot to adjust dynamics of the wearable robot. The computing device comprises at least one processor and memory in communication with the at least one processor. The memory comprises instructions that, when executed by the at least one processor, cause the at least one processor to apply an optimization algorithm to iteratively adjust the dynamics of the wearable robot. Each iterative adjustment of the dynamics of the wearable robot by the optimization algorithm comprises receiving at least one measurement from the at least one human parameter measurement device and adjusting the dynamics of the wearable robot based on the at least one measurement.

In another aspect, a method for customizing a wearable robot includes the step of receiving at least one measurement from at least one human parameter measurement device while a user performs an activity using the wearable robot. An optimization algorithm can be applied applying by a computing device to iteratively adjust dynamics provided by the wearable robot. Each iterative adjustment, by the optimization algorithm, of the dynamics provided by the wearable robot comprises receiving, by the computing device, at least one measurement from at least one human parameter measurement device; and adjusting, by the computing device, the dynamics of the wearable robot based on the at least one measurement.

In another aspect, a wearable robot has a joint. The wearable robot comprises an actuator configured to provide an adjustable torque about the joint. The wearable robot comprises at least one controller that is configured to receive an input from a remote computing device, wherein the input is indicative of an optimization of at least one human parameter measurement associated with a user of the wearable robot; and set a torque output provided by the actuator, wherein the torque output is selected based on the input received from the remote computing device.

### BRIEF DESCRIPTION OF THE DRAWINGS

FIG. 1 shows a flow chart for an overview of the Personalization Framework: The figure presents an overview of the personalization framework. The framework is divided into three parts: (A) Human-machine system: As an example, three different systems were demonstrated: ankle foot prosthesis—walking with individuals with simulated amputation, persons with below knee amputation, ankle Foot orthosis—walking and squatting with non-disabled individuals, and auditory command—step frequency for non-disabled, (B) Cost function estimation: cost was predicted using indirect calorimetry, electrocardiogram (ECG), prosthetic socket-residuum interface pressure, and foot contact force measures to evaluate the effectiveness of the personalized assistance, and (C) Bayesian Optimization: assistance parameters were optimized by generating the cost landscape (Gaussian process) and selecting the next parameter (Acquisition function).

FIGS. 2A-2C show a framework for ankle foot prosthesis personalization. FIG. 2A shows the personalization of prosthesis using the framework. FIG. 2B shows the two-day protocol used to find personalized assistance parameters using the framework and validate the experimental results. FIG. 2C. the metabolic costs and the comfort scores for two participants during the validation conditions.

FIGS. 3A-3C illustrate ankle foot exoskeleton personalization. FIG. 3A shows the personalization of orthosis for various speeds using the framework. FIG. 3B shows the two-day protocol used to personalize assistance using the proposed framework and validate the experiment. FIG. 3C shows the metabolic cost observed during the validation condition for two subjects at 3 different speeds.

FIGS. 4A-4C illustrate step frequency optimization using respiratory measures and ECG with two acquisition functions. FIG. 4A shows the personalization method using the framework, focusing on ECG-based measures. FIG. 4B shows the two-day protocol performed to test the framework and validate the hypothesis. FIG. 4C shows the optimization duration and the number of parameters explored for the personalization.

FIG. 5 shows a pseudocode algorithm for Bayesian Optimization.

FIG. 6 is a table showing case studies using the disclosed framework.

FIG. 7 illustrates Human-in-the-loop (HIL) ankle-foot prosthesis (AFP) stiffness parameter optimization and results. Torque trajectory using the stiffness parameter is indicated at (A). AFP Emulator with a participant with transtibial amputation, a.k.a below-knee amputation (BKA), walking with an interface pressure sensor is shown at (B). Residuum-socket interface pressure cost function is shown at (C). Bayesian optimization, which selects stiffness parameter based on the cost function, is shown at (D). A plot of HIL optimization outcome-Gaussian process of pressure cost for each stiffness iteration is shown at (E). A graph of Normalized peak pressure is shown at (F). A graph illustrating user comfort is shown at (G). A graph of metabolic rate of walking is shown at (H). A graph of perceived effort is shown at (I).

FIG. 8 illustrates parameter optimization for exemplary individuals. An experimental setup is shown at (A). Pearson's correlations between interface pressure and rate of perceived effort (RPE) and comfort are shown at (B) and (C), respectively. HIL Bayesian optimization (BO) outcomes from AFP settings are shown at (D-F). Gaussian process landscape shows AFP stiffness parameters and associated pressure costs at (D). Comparing optimal stiffness to fixed “motor holding” stiffness and customary AFP; higher cost and comfort indicates better outcomes, shown at (E-F).

FIG. 9A shows an experimental setup including the AFP end-effector, off-board actuation system, and pressure sensors attached to the residual limb. FIG. 9B is a graph showing log-transformed RPE vs. Normalized Pressure Objective graph. FIG. 9C is a plot showing Comfort vs. Normalized Pressure Objective graph. Each graph incorporates data from three subjects, distinguished by varying shapes and colors.

FIG. 10 is a schematic diagram of a system for customizing a wearable robot, as disclosed herein.

FIG. 11A shows a side view of an exemplary end effector of a prosthesis. FIG. 11B shows a perspective view of an exemplary end effector of a prosthesis. FIG. 11C shows an exemplary end effector in use on a treadmill.

FIG. 12 is a block diagram of an exemplary computing system comprising a computing device in accordance with embodiments disclosed herein.

FIG. 13 shows an exemplary pseudocode algorithm using phase plane estimation (PPE).

FIG. 14 shows an exemplary pseudocode algorithm using instantaneous cost mapping.

FIG. 15 shows an exemplary pseudocode algorithm using foot force-time integral (FFTI).

FIG. 16 shows a comparison of different acquisition functions for three 1-dimensional Gaussian process functions. In particular, FIG. 16 shows different acquisition functions for a given posterior distribution.

FIG. 17 shows RMSSD for seven conditions observed on day one in time-series. A cutoff-threshold presents the 60-second threshold used for the day two optimization.

FIG. 18 shows a plot of the correlation between the steady state metabolic cost and the root mean square of successive R-R (peak in the ECG data) interval differences (RMSSD) for the day 1 conditions.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, use of “substantially” (e.g., “substantially parallel”) or “generally” (e.g., “generally planar”) should be understood to include embodiments in which angles are within ten degrees, or within five degrees, or within one degree.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

Disclosed herein, in various aspects, is a system for providing personalized prostheses. The system can be provided for customizing a wearable robot. The wearable robot can be, for example, a prosthesis or an orthosis. Optionally, the wearable robot can be an ankle-foot orthosis or prosthesis. More generally, in some aspects, the wearable robot can be a below-the-waist prosthesis or orthosis. In some aspects, the wearable robot can be configured for below-the-knee (referred to herein also as “transtibial”) articulation. In further exemplary aspects, the wearable robot can be configured for above-the-knee articulation (e.g., for individuals having above-the-knee (referred to herein also as “transfemoral”) or at-the-knee amputations). In still further aspects, the wearable robot can be configured for providing hip articulation. Accordingly, in some aspects, the wearable robot can be configured for mobility. In still further aspects, the wearable robot can be an above-the-waist prosthesis or orthosis, such as, for example, a prosthetic arm. Accordingly, it is contemplated that embodiments herein can be used for optimizing wearable robots based on the specific use of the wearable robots and parameters measured during use thereof.

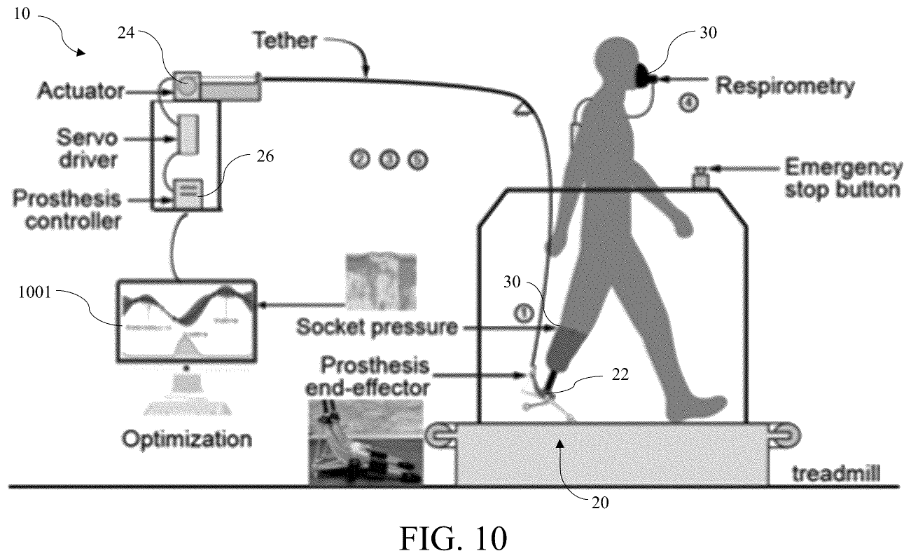

Referring to FIG. 10, a system 10 for customizing a wearable robot 20 can comprise at least one human parameter measurement device 30. The at least one human parameter measurement device 30 can comprise one or more of: an electrocardiogram (ECG), an indirect calorimetry device, a foot contact force sensor, a residuum-socket interface pressure sensor, or a prosthesis force sensor (e.g., a socket force sensor). In additional aspects, the at least one human parameter measurement device 30 can comprise an input device configured to receive user feedback. For example, the at least one human parameter measurement device 30 can comprise an input device (e.g., a keyboard, a mouse, or a touchscreen of a computing device such as a personal computer, smartphone, tablet) that is configured to receive a rate of perceived exertion and/or a comfort rating. Optionally, in some aspects, the system 10 can use only one human parameter measurement device 30. In other aspects, the system 10 can use a plurality of human parameter measurement devices 30.

The system 10 can further comprise a computing device 1001 configured to receive feedback from the at least one human parameter measurement device 30. The computing device 1001 can be further configured to communicate with the wearable robot 20 to adjust dynamics of (e.g., a movement profile provided by) the wearable robot. The computing device can comprise at least one processor and memory in communication with the at least one processor. The memory can have instructions that, when executed by the at least one processor, cause the at least one processor to apply an optimization algorithm to iteratively adjust the movement profile provided by the wearable robot 20. For example, each iteration of the optimization algorithm can comprise receiving at least one measurement from the at least one human parameter measurement device and adjusting the dynamics of (e.g., the movement profile provided by) the wearable robot 20 based on the at least one measurement.

The wearable robot 20 can comprise a joint 22 (e.g., a pivot axis) that provides a degree of freedom. In various aspects, the wearable robot 20 can have only one single joint providing one degree of freedom. In other aspects, the wearable robot 20 can have a plurality of joints, each joint providing a respective degree of freedom.

In some aspects, the dynamics of the wearable robot can include, for example, a torque about a joint of the wearable robot. In these aspects, the wearable robot 20 can comprise an actuator 24 that provides a torque about the joint. In other aspects, the dynamics can be directed by a spring rate. For example, the wearable robot 20 can be configured to adjust a variable spring rate that permits adjustment of a resistance to pivotal movement about a joint (e.g., torque as a function of deflection from a first position about the joint 22). The variable spring rate can be linear or nonlinear. More generally, the dynamics of the wearable robot can comprise an amount of power delivered and/or a speed at which the wearable robot moves. For example, the dynamics of the wearable robot can include a speed of movement about the joint. In some aspects, the dynamics of the wearable robot can be consistent throughout a range of motion of the wearable robot. In other aspects, the dynamics of the wearable robot can be variable throughout the range of motion of the wearable robot. In still further aspects, the dynamics of the wearable robot can include a position of at least a portion of the robot. For example, a portion of the robot can be configured to lengthen, shorten, change a set pivotal position, etc. to adjust the dynamics of the wearable robot. Optionally, the wearable robot can comprise at least one actuator that is configured to modify an interface with a residual limb of the user. For example, the wearable robot can comprise at least one panel defining a socket of the wearable robot that is configured to move to adjust an interface pressure with the residual limb. Accordingly, the dynamics of the wearable robot can further include adjustment of the interface with the residual limb (e.g., modifying pressure applied by a movable panel) to relieve pressure. In this way, limb swelling can be managed.

In various aspects, the optimization algorithm can comprise a Bayesian optimization algorithm. For example, the Bayesian optimization algorithm can comprise the steps of generating a posterior distribution and selecting a new parameter associated with the dynamics of the wearable robot. In some aspects, the posterior distribution can be generated by a Gaussian process.

The optimization algorithm can be configured to adjust the dynamics of the wearable robot based on the at least one measurement using Expectation of Improvement (EI) and/or a Monte Carlo sampling-based acquisition function.

In some aspects, the optimization algorithm is configured to optimize based on a particular activity. For example, the optimization algorithm can optimize for walking at a specific speed. In further aspects, the optimization algorithm can optimize for running. In additional aspects, the optimization algorithm can optimize for other activities, such as squatting or weightlifting.

A method for customizing a wearable robot 20 as disclosed herein includes the step of receiving at least one measurement from at least one human parameter measurement device while a user performs an activity using the wearable robot. An optimization algorithm can be applied to iteratively adjust a dynamics characteristic of by the wearable robot. Each iteration of the optimization algorithm includes the steps of receiving at least one measurement from at least one human parameter measurement device and adjusting the dynamics of the wearable robot based on the at least one measurement.

In some aspects, the wearable robot can comprise a plurality of degrees of freedom. Optionally, in these aspects, the wearable robot is configured to independently adjust a respective dynamics characteristic about each of the plurality of degrees of freedom. The method can optimize for each dynamics of about each degree of freedom of the plurality of degrees of freedom.

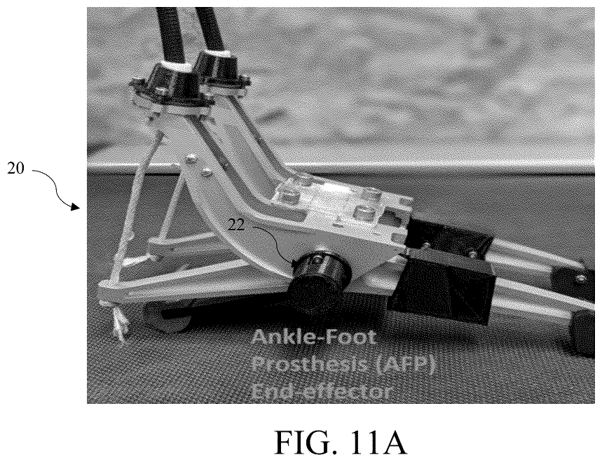

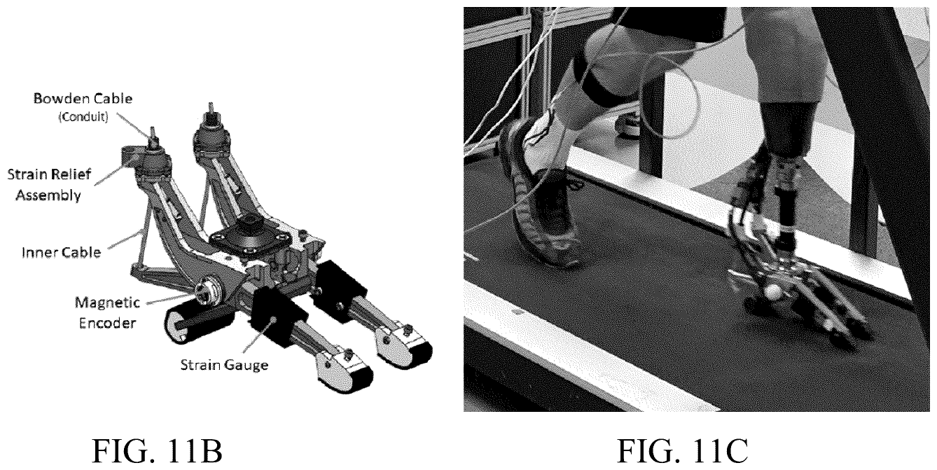

Wearable robots that are customized using the disclosed systems and methods are also contemplated. For example, referring to FIGS. 10-11C, a wearable robot 20 has a joint 22 and an actuator 24 configured to provide an adjustable dynamics profile, such as, for example, a torque or torque rate (e.g., torque as a function of deflection from a first position) about the joint. The wearable robot can further comprise at least one controller 26 that is configured to receive an input from a remote computing device. The input can be indicative of an optimization of at least one human parameter measurement associated with a user of the wearable robot. The controller can further be configured to set a torque output provided by the actuator, wherein the torque output is selected based on the input received from the remote computing device. Accordingly, the controller can set a dynamics profile based on the user. Further, the wearable robot can be optimized for the user for two or more activities, and the controller can cause the actuator to provide the dynamics profile based on the activity (e.g., as selected by the user). For example, a first activity can be walking and a second activity can be running. Optimal dynamics can differ between said first and second activities. Accordingly, in some aspects, the user can select between the activities, via the controller, and the wearable robot can adjust the dynamics profile based on the selected activity.

As noted herein, a below-knee-amputation (BKA) is the most common type of major amputation worldwide. The individuals with BKA consider comfort as one of the top priorities, which is related to user mobility. The prosthetic socket is a crucial component as the interface between the user and the prosthesis. Socket geometry and materials have been studied to improve socket design, including fitting, load transmission, alignment. The effects of prosthesis alignment on load transmission can be observed through residuum-socket interface pressure. Previous research has attempted to reduce interface pressure below a certain threshold through discrete prosthesis alignment adjustments. However, it is challenging to reduce interface pressure because interface pressure is a function of multiple factors such as user body mass, regional pressure tolerance or changes due to swelling, and the socket design. A socket design is highly varied across individuals due to differences in residual limb tissue composition, geometry and intended prosthetic components to be used distal to the socket.

Accordingly, embodiments disclosed herein provide prosthesis adjustment methods for minimizing interface pressures in order to increase user comfort and prevent residuum health complications. Here, the prosthesis dynamics are optimized according to the cost function built on interface pressure to maximize user perceived comfort. Adjusting the prosthesis mechanical properties, which can have similar effects on load distribution to componentry alignment, can be a more accurate and precise method than conventional methods for reducing interface pressure.

### Computing System

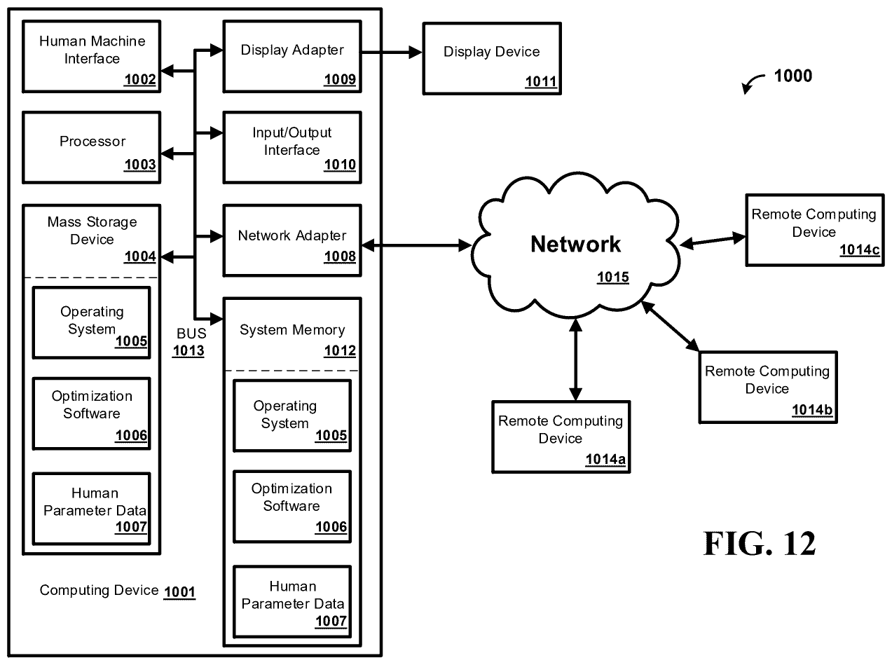

FIG. 12 shows an exemplary computing system 1000 including an exemplary configuration of a computing device 1001 for use with the system disclosed herein. The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as human parameter data 1007 and/or program modules such as operating system 1005 and optimization software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and optimization software 1006 may be stored on the mass storage device 1004. One or more of the operating system 1005 and optimization software 1006 (or some combination thereof) may comprise program modules and the optimization software 1006. The human parameter data 1007 may also be stored on the mass storage device 1004. The human parameter data 1007 may be stored in any of one or more databases known in the art. The databases may be centralized or distributed across multiple locations within the network 1015.

A user may enter commands and information into the computing device 1001 using an input device. Such input devices comprise, but are not limited to, a joystick, a touchscreen display, a keyboard, a pointing device (e.g., a computer mouse, remote control), a microphone, a scanner, tactile input devices such as gloves, and other body coverings, motion sensor, speech recognition, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. The remote computing devices 1014a,b,c, can perform respective operations of the system 10. For example, one remote computing device 1014a can be a controller of a first pivotable structure 22. One remote computing device 1014b can control a second pivotable structure 24. Logical connections between the computing device 1001 and a remote computing device 1014a,b,c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In various further aspects, it is contemplated that some or all aspects of data processing described herein can be performed via cloud computing on one or more servers or other remote computing devices. Accordingly, at least a portion of the system 1000 can be configured with internet connectivity.

### EXAMPLES

### Example 1

### Introduction

One of the successful personalization methods is a data-driven approach known as Human-in-the-loop (HIL) optimization [1], [4], [15]-[19]. HIL optimization often uses a physiological [1], [3], [16], or kinematic measure [2], to increase the effectiveness of wearable robots in decreasing user's physical effort during walking [2], [3], [5], [16], and various activities [1], [4], [20]. Several HIL optimization methods have been proposed focusing on the optimization algorithm. Felt et al. presented one of the early implementations of the personalization method, called body-in-the-loop optimization. In that study, directly minimizing energy consumption using a physiological outcome, namely respiratory measure, could allow users to converge onto an energy-efficient cadence. For the optimization method, the authors used a gradient descent search algorithm. Kim et al. used a non-parametric, sample-efficient, and noise-tolerant method, Bayesian optimization (BO), to identify an energy-efficient step frequency. Using BO, the HIL optimization identified the optimal parameters twice as fast as the method proposed by Felt. et al. [19]. Then, the HIL BO method was used to identify an optimal parameter in a soft exosuit [16], which reduced the metabolic cost of walking by 17% compared to not wearing the exoskeleton. Zhang et al. [3] used a genetic algorithm, covariance matrix adaptation evolution strategy (CMA-ES), to personalize ankle exoskeleton assistance, which reduced the metabolic cost of walking by 24%, compared to the zero-torque condition. This HIL optimization approach was further expanded to other activities of daily living, such as running [4] and walking at various speeds [20]. However, the genetic algorithm-based parameter optimization takes a substantially long time to identify the optimal parameter [3], [20], [21].Considering the practical need for minimizing in-vivo experimental time, the HIL Bayesian optimization [16], [17], [22], might be applicable to various populations and clinical groups, including individuals with reduced physical strength and physically intensive activities, due to its sample efficiency and ability to quickly identify an optimal condition.

Researchers have investigated faster cost function estimation to reduce the optimization time and improve user comfort. One of the methods is reducing the steady-state metabolic cost using a phase plane estimation (PPE) instead of the time domain method. This data-driven PPE method determined the steady-state metabolic cost twice as fast than the conventional method using Gaussian mixture regression [24]-[26]. The effectiveness of this PPE method in a cost function was tested by HIL Bayesian exoskeleton parameter optimization during a squat [1]. With the new estimation method, two optimal parameters were found in 15 min, which helped to reduce steady-state metabolic cost by 20% compared to the no-device condition [1].

Other alternative cost functions have been developed. Jacobson et al. [2] showed that a symmetric function in the form of force time integral could be used as a proxy measure in place of the metabolic cost for the individuals with simulated amputation. The new cost function was used to identify personalized assistance in an ankle-foot prosthesis during walking. Han et al. and Jeong et al. showed that muscle activity-based measures could be used in HIL optimization. Slade et al. [5] used device measurements and a data-driven estimation process to personalize exoskeletons in the outdoor environment. Ingraham et al. demonstrated that optimal assistance of an exoskeleton could be inferred using subjective feedback and user preference. These different cost functions could help optimize assistance in outdoor and more dynamic environments.

In addition to kinematic and calorimetric measures, several electrocardiogram (ECG) measures have shown a correlation with exercise intensity [30]-[32] with a less noisy and faster response than metabolic rate [33]. Therefore, ECG-based optimizations may result in faster optimizations compared to the use of the indirect calorimetric measure. This toolbox incorporated the root mean square of successive R-R (peak in the ECG data) interval differences (RMSSD), a widely used ECG feature, as the candidate cost function [34]. RMSSD is a time series function that is relatively easier to compute than the non-linear or frequency-based cost functions [35]. This function correlates with exercise intensity and could be a valid indicator of metabolic cost [31], [35]-[37].

The progress in personalization has been significant; however, various optimization [1], [3], [5], [16], [20], and cost estimation methods [5], [22], [38], typically involve custom optimization setup. In addition, a new system would require significant tuning and reprogramming of the communication system between the optimization outcomes and wearable robots [1], [17]. This variability and tuning increases the barrier to entry for exoskeleton (and prosthetic) personalization.

Accordingly, disclosed herein is a HIL optimization framework with a communication protocol-lab-streaming layer (LSL)1. LSL, is a TCP-based network communication protocol that has been implemented in various physiological sensors as it allows near-real-time access to time series information and synchronization. This setup can be modular, capable of configuring the cost function and optimization methodologies.

To demonstrate the capabilities of the proposed framework, a proof-of-concept study of the framework was performed in three different case studies with varying cost function (metabolic cost, ECG, foot pressure), varying subject populations (individuals with below knee amputation, Non-disabled individuals) and varying assistance devices (ankle-foot prosthesis, ankle exoskeleton, and walking step frequency). This example is divided into three different sections. In the first section, the framework is introduced in detail by explaining different modules: human-machine system, cost function estimation, and the Bayesian optimization module. The framework is validated via three case studies, (1) HIL ankle-foot prosthesis parameter optimization with individuals with transtibial amputation; (2) HIL robotic exoskeleton parameter optimization for various walking speeds; (3) HIL gait parameter optimization using a different cost function and Bayesian optimization variants. Finally, this framework's potential impact and results from the case studies are discussed.

### Framework

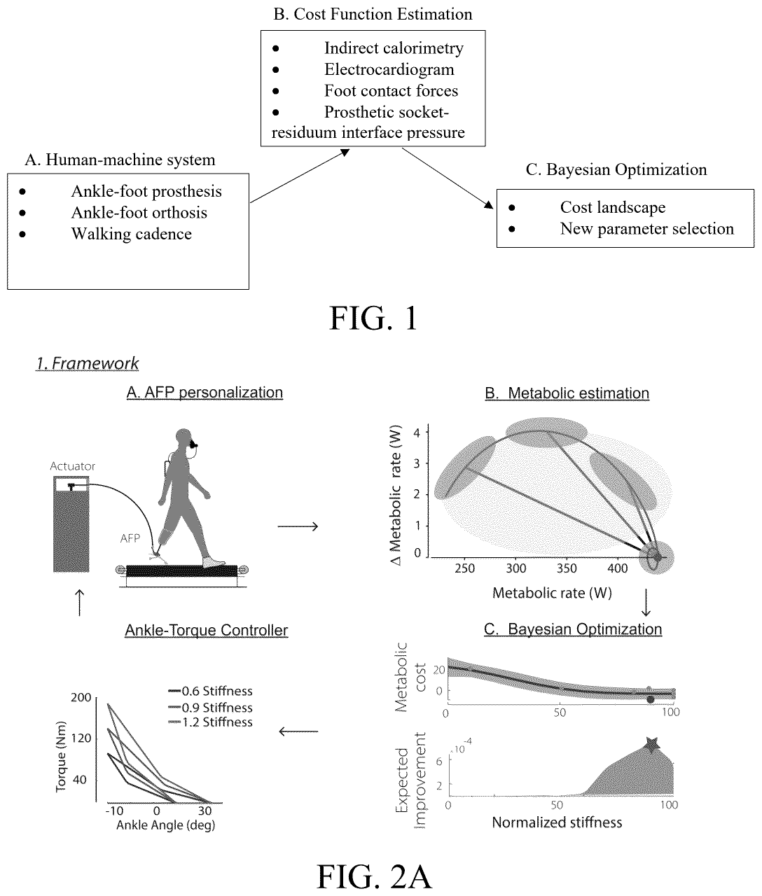

A framework for the system for providing personalized prostheses comprises three components: A) human-machine system, B) Cost function estimation—to predict user outcomes given assistance, and C) Bayesian optimization—to evaluate cost landscape given assistance and measured costs, and then select the next parameter (FIG. 1). A comprehensive explanation of these components is provided in this section.

### A. Human-Machine System

The first module of this framework is the human-machine system. In particular, the framework is configured to optimize the machine parameter to meet each human's needs. The machine can be a wearable robot (e.g., robotic ankle-foot prosthesis or robotic ankle-foot orthosis) or commands from a device (e.g., auditory cues). The machine provides assistance, and the human conducts an activity given assistance while interacting with the machine. In this framework, parameters for three human-machine systems were personalized.

1. Robotic ankle-foot prosthesis (AFP) emulator: A two degree-of-freedom robotic ankle-foot prosthesis with an active plantarflexion and in/eversion was used [40]. This AFP comprises an aluminum frame, two toes, and a compliant heel. The compliant heel uses a heel fiberglass spring (Gordon Composites, Montrose, CO). The rotation of each shaft-toc assembly resembles the natural dorsiflexion and plantarflexion of an anatomical ankle joint. Two encoders mounted to the frame measured the angle for each toe's axis, and a load cell was used to measure the actual torque observed. This AFP provides assistance by providing ankle torque during the stance phase of the gait cycle. The level of assistance is determined using a predefined ankle-torque curve parameterized with stiffness parameters.

This parameter has been personalized iteratively using a foot pressure sensor [2] or respiratory measures for individuals with simulated amputation. This study further developed a framework structure and tested it on two individuals with transtibial amputation (Case Study 1).

2. Robotic ankle-foot Orthosis (AFO): The one-degree-of-freedom robotic ankle exoskeleton (AFO) (Humotech, Pittsburg, PA) was used as another machine system interacting with a human [7]. The exoskeleton provides assistance based on a predefined, parameterized ankle-torque curve. The parameter was personalized here through a human-in-the-loop optimization algorithm for a squatting activity using an ankle exoskeleton [1] similar to [7]. Based on this method, a framework walking assistance was developed and tested (Case Study 2).

3. Walking cadence: Walking cadence optimization has been used to evaluate human-in-the-loop optimization methods [18], [20]. An audible metronome tone and a human system were used to test the personalization algorithm performance using a new cost function based on heart rate and acquisition functions. Details of the optimization can be found in the (Case Study 3).

### B. Cost Function Estimation

The user outcome given assistance is recorded and used to determine the best assistance for the user. The cost function estimation is the module to determine the user's physical effort using physiological signals [41]. In this framework example, three signals have been used to quantify the effect of the assistance.

1. Indirect calorimetry: This sensor information was used to estimate the conventional metabolic cost [23], [39], [42]. Breath-by-breath VO2 and VCo2 were measured using a respiratory measure (K5, Cosmed, Italy). The metabolic rate was calculated using VO2 and VCo2 based on the Brockway equation [43]. The sensor was calibrated before every session, and respiratory data were monitored using the COSMED Omnia (data collection application and real-time SDK). The metabolic rate is transferred to LSL using a custom python script. Using this real-time metabolic rate, the steady-state metabolic cost was estimated using Phase plane estimation (PPE) and Instantaneous Cost Mapping (ICM).

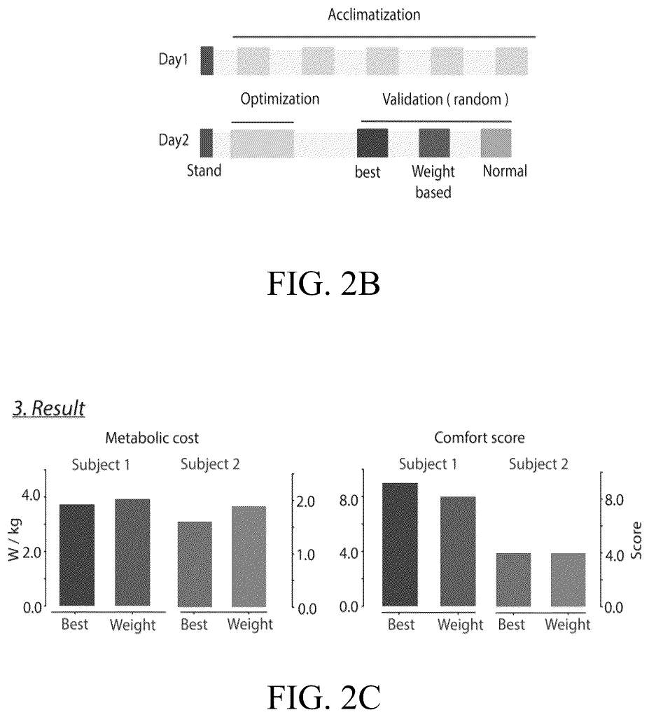

Phase plane estimation (PPE): PPE is a fast, data-driven metabolic cost estimation method proposed in our previous work [23]. This method transforms the time-series metabolic rate to the phase plane. In this phase plane, the forward difference of the metabolic rate is mapped into the vertical axis, and the metabolic rate is described in the horizontal axis (FIG. 2A). The steady-state metabolic cost estimate does not change over time; hence, it can be assumed that the steady-state metabolic cost is a point on the horizontal axis where the vertical axis value is zero. The Bayesian Gaussian mixture clustering [24], was used to cluster the data in the phase plane and estimate each cluster's mean μ and covariance Σ. The Gaussian mixture means and covariance were used to estimate the steady state point on the X-axis, as shown in the equation below

$$steady state = \frac{{\sum }_{k}^{K} {A}_{k}}{{\sum }_{k}^{K} {B}_{k}}$$

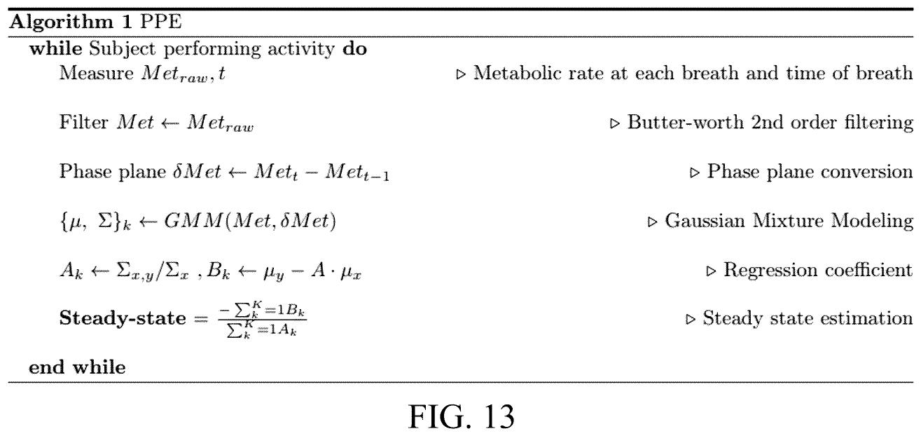

A and B are the regression coefficients for each cluster k given by Σ_{x,y}/Σₓ, and μ_{y}−A·μₓ. This estimation is performed for each breath. Implementation details and comparisons are presented in [1], [23]. The step-by-step algorithm is provided in FIG. 13.

Instantaneous Cost Mapping (ICM): ICM is a commonly used estimation method for HIL optimization [3], [4], [15], [18], [19]. The metabolic rate and steady-state metabolic cost are modeled as a mono-exponential model. A discretized version of this method is presented as follows,

$$z ( i + 1 ) = \frac{τ - dt ( i )}{τ} \cdot z ( i ) + \frac{dt ( i )}{τ} \cdot {z}^{*}$$

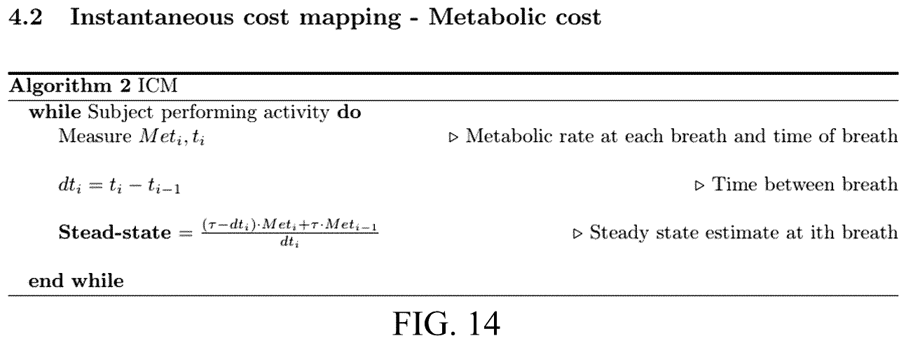

Here, z(i) is the metabolic rate measured at the time (i), and z* is the steady-state metabolic cost function that needs to be estimated. The dt(i) is the time difference between the breath i and the next breath i+1, and τ is the time constant. t was initialized in this system as 42 based on the Selinger et al. recommendation. However, this parameter needs to be changed based on the activity, as suggested by [4]. A detailed algorithm is presented in FIG. 14

2. Electrocardiogram (ECG): A recent study found that ECG information can be used to predict metabolic cost [41]. In this study, ECG was measured using a polar H10 chest strap (Kempele, Finland) and was filtered using a real-time filter [45]. The sampling rate of the ECG sensor was fixed at 130 Hz. Data is streamed over Bluetooth low-energy (BLE) protocol and captured by a custom python script which transfers it to LSL every 1 sec. If there was a disconnection or a sensor failure during optimization and data collection, sensors were repositioned and the procedure was restarted.

R-R (peak in the ECG data) interval differences: We used the root mean square of successive R-R interval differences (RMSSD) to estimate energy expenditure [41]. To calculate the RMSSD in real-time, we first filtered the ECG data using a 0.5 Hz high-pass 5th-order Butterworth filter and removed any linear drift. The R-R peaks were identified using the method proposed by Kalidas et al. [46]. The time intervals between R-R peaks were squared and averaged for a time range. The square root of the average was used as the cost function. We used the neurokit2 library and the custom python-based data processing pipeline for real-time cost estimation. For this experiment, we used the 30s intervals for R-R peaks identification and for cost calculations [48].

3. Foot contact forces: In our prior work, we have shown that foot contact forces can be used to predict the energy expenditure of walking [2]. The contact forces were measured using F-scan foot pressure sensors (Tekscan, MI, USA). These sensors are placed over the left and right insole and calibrated using the F-scan step calibration method [2]. Both sensors have 25 sensels per square inch, and pressure information at each sensel is transferred using the USB communication protocol and accessed through Tekscan API at 120 Hz. In our previous implementation, the data was obtained using MATLAB, but in this framework, we have set up the acquisition using a custom python application to integrate this physiological measure into the proposed framework. This data is sent to LSL every 1 sec.

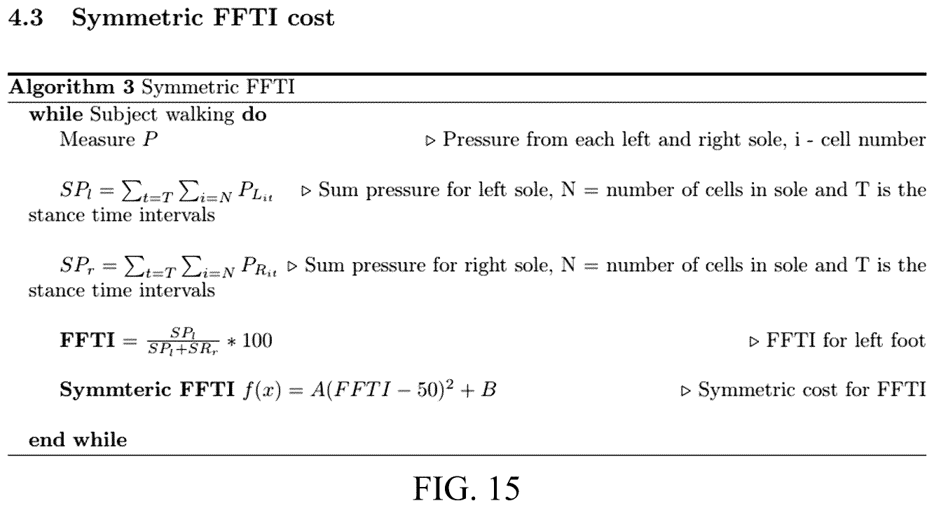

Foot force time integral: Foot force-time integral (FFTI) [2] estimates the metabolic cost of steady-state walking using gait asymmetry information. For each left and right limb, we first calculated the foot contact force applied during walking and integrated it across the stance phase. This value was used to calculate the symmetric index (SI) [49]. The SI was used to determine the asymmetric cost and estimate the approximate metabolic cost (details are described in our previous study [2]). The detailed algorithm and step-by-step instructions are provided in FIG. 15.

### C. Bayesian Optimization

In this framework, BO is a module that optimizes a parameter given various cost functions (FIG. 1) and device parameters (FIG. 1). BO is a semi-global, non-parametric, and noise tolerant method [50], [51]. Typically, BO involves two sequential optimization steps; the first is the generation of the posterior distribution [35], [36], and the second is sampling the next optimization point using the acquisition function.

1. Cost landscape: We used the Gaussian process (GP) as the posterior function for its sample efficiency, non-parametric, and noise tolerance characteristics [52], [53]. This function uses the data and kernel functions to estimate the posterior function, with mean and covariance at each point in the sample space.

The construction of the posterior function's mean and covariance at each point (xx) on the sample space can be found in Algorithm 1. Here, kₙ is a vector obtained by applying the kernel function (k) on known data points xₙ and sample space x, in the form kₙ=k(xₙ, x_{*}). K is the matrix obtained by applying kernel function (k) on the entire sample space (x_{*}) in the form K=k (x_{*}, x_{*}). The σₙₒᵢₛₑ is the hyper-parameter tuned during the construction of the Gaussian process. The hyper-parameter training is detailed in the supplementary material (section 3).

We used the squared exponential (SE) kernel as a standard practice [1], [15]. It is easy to switch kernels depending on the applications. Supplementary section 1 explains the kernel options and expected behavior for each kernel.

2. New parameter selection: The new parameter was typically selected using the posterior function's mean and standard deviation to identify the next sampling point while balancing between exploration and exploitation. In this example, we mainly used Expectation Improvement (EI) [54], explained in the Acquisition function section in Algorithm 1. The μₓ. and the σₓ, are the mean and standard deviation of the posterior function (Gaussian process) at each point x_{*} in the sampling space. The f_{best}-best output observed with the sampling point is used to construct a matrix (V_{x*}). The matrix calculation depends on the acquisition function (e.g., EI, Probability of improvement (PI), Upper Confidence Bounds (UCB) [54]). The sampling points corresponding to the maximum value are selected as the next points in the optimization loop (argmax (Vₓ) in the algorithm). Several other methods, such as noisy EI or Monte Carlo-based functions [55], [56], can be used depending on the application. In supplementary section 3, we provide a detailed explanation of regularly used acquisition functions and compare the performance of these acquisition functions for a standard optimization procedure.

### III. Case Studies

### (Case Study 1) Ankle Foot Prosthesis (AFP) Optimization

We tested the proposed HIL optimization framework to personalize AFP assistance for individuals with transtibial amputation (FIG. 2A). The primary motivation of this case study was to test the feasibility of the proposed framework with various populations. We used the conventional metabolic cost-based optimization and validated the personalized assistance with a weight-based, generic condition and a prescribed prosthesis condition (FIG. 2B).

### 1. The Personalization Framework

Human-machine system (Robotic AFP Emulator): We used the AFP emulator described in Section II.A.1. The device could generate the maximum plantarflexion torque by 140 Nm; however, we set the torque threshold as 120 Nm, considering the safety of the subjects and the device.

The control system was composed of two levels of controller: a low-level controller and a high-level controller. The low-level controller tracked the desired torque using a proportional controller based on the torque error between desired and measured torques. The high-level controller generated the desired ankle angle and torque curve using the stiffness parameter from the BO module.

(B) Cost function (respiratory measure): We used the metabolic cost of walking using the respiratory measure using the PPE algorithm. We used 1.5 min data per each optimization condition.

(C) Bayesian Optimization: The BO module iteratively fitted the data to the GP landscape and then selected the next parameter using the EI. The parameter scale ranged from 0.5 to 1.4 N/deg for subject 1 and 0.5 and 1.5 N/deg for subject two for the study below. The range was selected based on the subject's weight, age, and height and kept constant throughout the experiment.

### 2. Experimental Protocol

We tested the personalization method with two individuals with transtibial amputation (age: 38 and 59 yrs, prosthesis use: 17 and 23 years, weight: 95 and 60 kg, Height: 185 and 170 cm, male and female) using two days experimental protocol (FIG. 2B) (Protocol No: UIC IRB 2019-0087). We collected the respiratory measures and, additionally, user comfort with a comfort score adapted from the socket comfort score [57][0-10, 10 is the most comfortable device for walking, and 0 is very uncomfortable].

On Day 1, the robotic ankle-foot prosthesis end-effector was fitted to the participant by a certified prosthetist. Then, the subject was instructed to walk for five stiffness conditions for 5 min, composed of the control off condition (motion position constant) and four conditions with different assistance profiles. 5 min rest was given in between trials.

On Day2, two-minute initial conditions were performed to validate the attachment of the prosthesis. Then, the HIL optimization was conducted for 14 min. Following the optimization, the optimal, weight-based condition (sub 1:0.8, sub 2:0.6 [10% of body weight in kg] [2]) and their prescribed (customary) prosthesis were evaluated. 1:1 rest time was provided for all the conditions on Day1 and Day2.

### 3. Results

The personalized assistance (best condition) was identified for Subjects 1 and 2, shown by reduced metabolic cost by 5.6% and 18.1% for the personalized, best condition compared to the weight-based condition. For the prescribed prosthesis condition, Subject 1's steady state metabolic cost was 4.61 W·kg⁻¹. which was 23.5% higher than the personalized condition. Subject 2's metabolic cost was 1.40 W·kg⁻¹. which was 14% lower compared to the best condition.

Subject 1 reported that robotic AFP was more comfortable compared to their prescribed prosthesis, with a comfort score of 9 and 8 for the best (personalized) and weight-based condition and 7 for their prescribed prosthesis. Subject 2 reported that both the weight-based and personalized assistance had the same comfort scores of 4, while their prescribed prosthesis scored a 9. These comparisons between the weight based and the optimal condition show that our framework can be successfully applied to different populations, including clinical groups.

### (Case Study 2) Speed-Specific Personalized Assistance

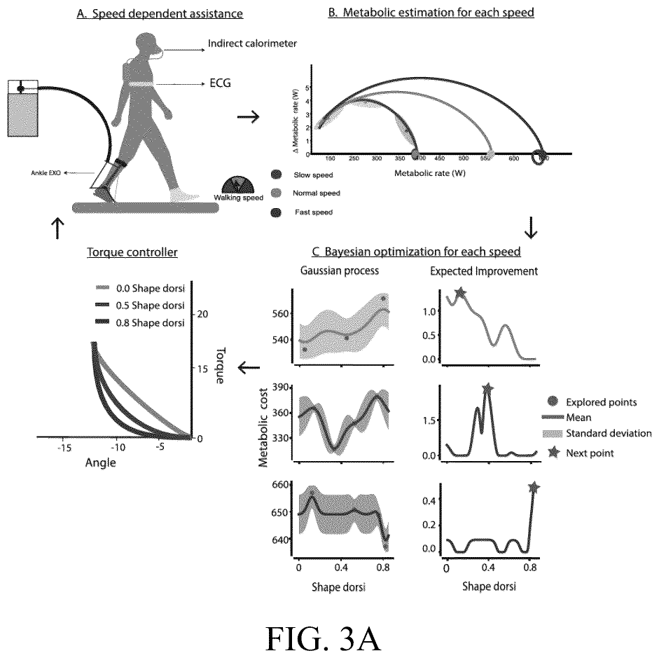

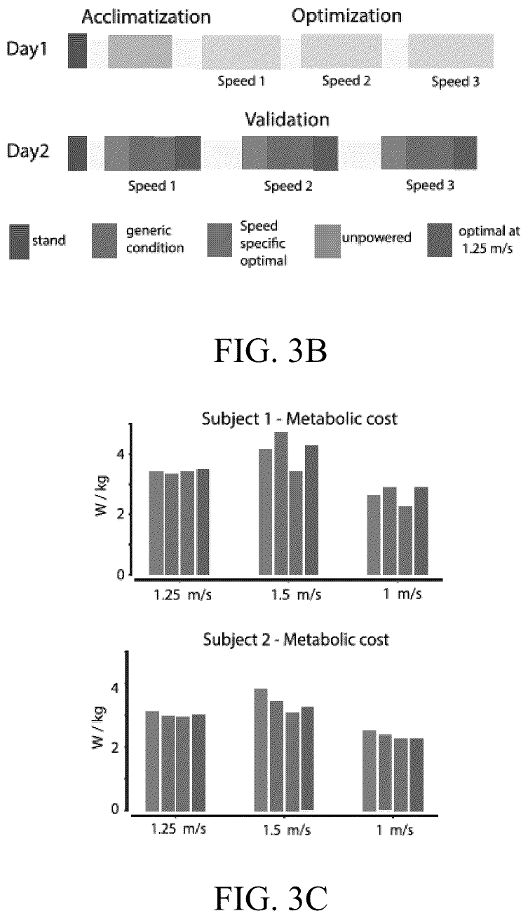

We tested the framework for various activity conditions in non-disabled individuals (FIG. 3.1), in this case, speeds (1 m/s, 1.25 m/s, and 1.5 m/s), as we hypothesized that the personalized assistance would be different for different speeds; hence, the framework should work for various activities. We tested by comparing the user outcomes from the speed-specific, personalized assistance condition to the generic and optimal assistance identified at normal walking speed (FIG. 3.2).

### 1. The Personalization Framework

(A) Human-machine system (Robotic AFO Emulator): We used a 1-degree of freedom (DOF) and tethered ankle exoskeleton (Humotech, Pittsburg, PA). We divided the gait cycle into swing and stance phases. These stages were identified using the heel and toe switches. During the swing phase, we used a zero-motor velocity controller so the subject could freely move to the next step. During the stance phase, the low-level controller conducted the torque control to track the desired torque. The high-level controller generated the desired torque curve based on the ankle angle and a shape-dorsi parameter (FIG. 3.1, Torque controller) from the BO module.

(B) Cost function (respiratory measure): We estimated the metabolic cost of walking at three different speeds using the PPE method and the respiratory measures.

(C) Bayesian Optimization: We performed optimization for each speed separately using metabolic cost as the cost function. To estimate the cost landscape, we used the GP with SE kernel, and for the acquisition function, we used EI. The shape-dorsi parameter range was 0-0.85 based on subject weight and device control range.

### 2. Experimental Protocol

A two-day protocol was used to identify and validate the speed-specific optimal assistance (FIG. 2B) with two subjects (Male, age: 27, 19 years, weight 91, 75 kg, Height 185, 172 cm) (Protocol: UIC IRB 2020-0563). The walking speeds for low, medium, and high were 1 m/s, 1.25 m/s, and 1.5 m/s, respectively.

On Dayl, we performed an exoskeleton acclimatization trial at different speeds. During this trial, the subject walked at three different stiffness conditions for 2 min each for low, medium, and high-speed conditions (Order randomized for each subject

After each speed condition, a 7 min rest time was allocated for the subject. Following this acclimatization period, we performed the HIL optimization for each speed. Typically, the optimization process took 12 minutes, during which the optimizer selected consecutive parameters that indicated the best point. After each optimization, 7 min sitting rest time was provided to the subject.

On Day2, we validated the optimal parameters obtained on day one by comparing them with unpowered, generic conditions (fixed stiffness) and optimal conditions for normal speed. Each condition was further divided into three trials of 5 min for each speed. Between each speed trial, we provided 1 min of sitting rest time. After each condition, we provided 7 min of rest time. The order of each condition is randomized to reduce the ordering effect.

### 3. Results

The personalized assistance reduced steady-state metabolic cost for optimal conditions compared to unpowered conditions. The metabolic costs were reduced by 5.8% and 18.8% for 1.5 m/s speed for subjects 1 and 2, respectively. Each participant reduced the metabolic cost of walking by 1.8% and 2.0% for the optimal condition compared to the unpowered condition at 1.25 m/s. They also reduced the cost by 0.5% and 20.8% for the 1 m/s condition, respectively.

Compared to generic and normal speed's optimal conditions, for each speed, we observed that speed-specific optimal conditions reduced metabolic costs for all other conditions. Detailed results are tabulated in the supplementary material (Section 5) and are also presented in FIG. 3.3.

### (Case Study 3) Step Frequency Optimization Using ECG

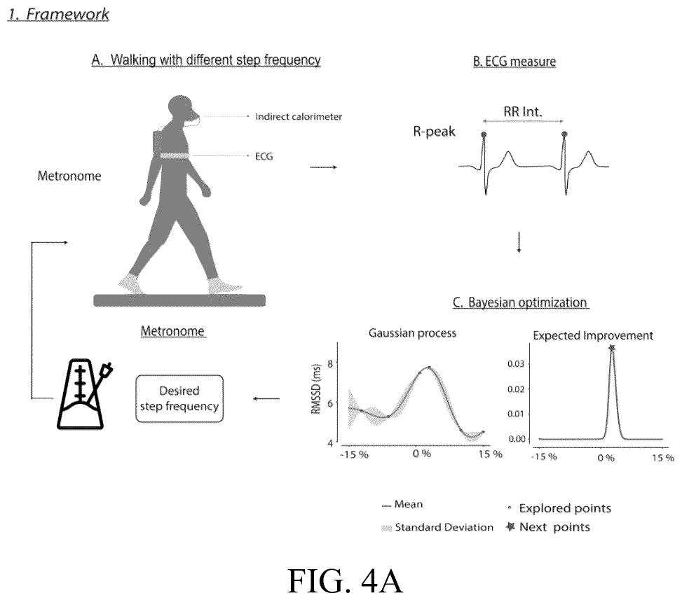

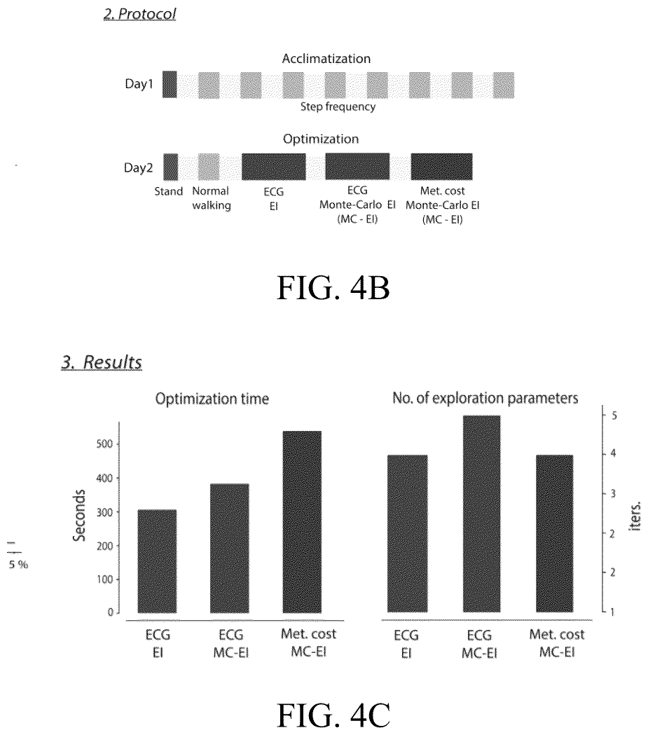

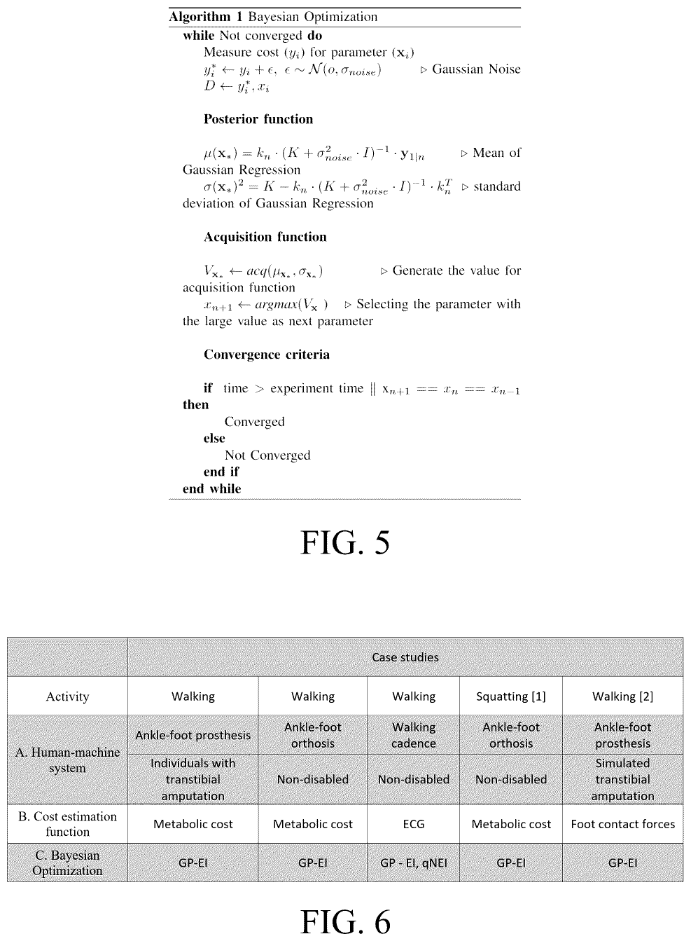

Step frequency optimization was conducted to demonstrate the compatibility of the framework for various options (FIG. 4.1): a different human-machine system, a new cost function option, in this case, a new cost function using the physical effort estimate from ECG, and acquisition functions in BO. Specifically, we optimized walking cadence, a common practice to test a new algorithm [18], [20]. Step frequency or walking cadence is naturally optimized for a given walking speed to reduce energy consumption [58]. Previous studies have used this information to test different optimization schema and cost functions [18], [20]. Since this step frequency optimization was previously used to compare the different optimization schema [18],[20], this study can be used to directly compare the current optimization framework with published results and traditional energy measures such as metabolic cost.

### 1. The Personalization Framework

(A) Human-machine system (an auditory cue): The subject was instructed to follow a metronome-set walking cadence, with a range set to ±15% of normal [18], [20]. We used a wireless speaker to deliver the metronome sound corresponding to the desired cadence.

(B) Cost function (respiratory measure and ECG): We estimated the steady-state metabolic cost of walking for different speeds using both respiratory measures using PPE and ECG using RMSSD outcomes. For the respiratory measure, the PPE updated the cost function every 1.5 mins, and for ECG-based optimization, the parameter was updated every 1 min, and the RMSSD cost was measured for the last 30 s based on the preliminary data analysis (supplementary material section 7) and literature [33].

(C) Bayesian Optimization: For the optimization using respiratory measure, we used conventional BO methods (GP for cost landscape and EI for the acquisition function) to serve as a baseline [1], [2], [22].

For the optimization using ECG outcomes, we used two acquisition methods: Expectation of Improvement (EI) and MC-EI: a Monte Carlo sampling-based acquisition function [55], [56].

### 2. Experimental Protocol

We performed step frequency optimization for one subject for two different cost functions and acquisition functions (Male, Age: 27, Height: 185 cm, weight 90 kg) (protocol: UIC IRB 2020-0563). The subject experienced a two-day study protocol (FIG. 4.2).

On Day 1, the subject acclimated to eight conditions of walking-normal walking (no metronome), ±15%, ±10%, and ±5% of the preferred step frequency in random order. The preferred step frequency was measured during the normal walking condition. We also collected the ECG and respiratory measure outcomes to find a correlation to predict the metabolic cost and to investigate the response time to reach a steady state (Supplementary material Section 7). This information was used in the optimization setup.

On Day 2, the participant experienced normal walking and three optimization conditions-one metabolic cost-based optimization and two ECG-based cost functions, with different acquisition functions.

On both days, the subject wore an indirect calorimetry device (Cosmed K5) to measure the metabolic cost and a Polar H10 chest strap to measure the ECG. The researchers continuously monitored the subject's cadence, and if the subject missed the time or was not following the cadence (Metronome), we verbally prompted them to follow the cadence.

### 3. Results

All three optimization successfully identified a close-to-natural step frequency within this framework (FIG. 4.3). For the metabolic-cost-based optimization with EI as the acquisition function, the optimization identified 0.86% difference compared to the natural step frequency as the optimal condition in 4 iterations. It took 539 s, including 2 min warm-up, similar to the previous metabolic cost-based optimization methods [1], [18], [20].

For the ECG-based cost function with El acquisition function, 0.88% difference compared to the preferred step frequency was identified as optimal within 4 iterations. Total optimization time, including a warm-up walk of 2 min, was 306 s. For the ECG-based cost function with a Monte-Carlo sampling-based cost function (q-Noisy EI-qNEI), a 2% difference from the preferred step frequency was found to be optimum in 5 iterations. This optimization took 383 s with the warm-up.

### IV. Discussion

We have developed a modular, personalization framework composed of a human-machine system, cost function estimation, and BO. The framework was tested with various A) human-machine systems, including individuals without disabilities and with transtibial amputation, robotic ankle-foot prosthesis and orthosis, and metronome-set gait; B) cost functions using respiratory measures and ECG; and C) BO with different acquisition functions (Table I, FIG. 6). all scenarios, the personalized assistance reduced the metabolic cost compared to generic or control-off conditions. These results suggest that the proposed framework can be used to personalize assistance while accommodating diverse population-machine systems, cost functions, and BO variants. The framework application also presented its abilities in two different scenarios: assisted squatting activity with non-disabled and robotic AFO system (A), utilizing metabolic cost estimation (B) and a regular BO (C) [1]; and assisting walking with individuals who had a simulated amputation using robotic AFP (A), physical effort estimation using foot contact forces (B), and regular BO (C) [2].

Case study 1. Ankle foot prosthesis (AFP) personalization: When the framework was used to personalize assistance for individuals with transtibial amputation, the personalized assistance resulted in a maximum of 5.6% and 18.1% reductions for Subjects 1 and 2, respectively, compared to the generic condition. For this scenario, we estimated the cost using the fast metabolic cost estimation method along with a regular BO module. This reduced the total optimization time to 12 min, three times faster than the conventional CMA-ES (Covariance matrix adaptation evolution strategy) based HIL optimization [11]. The proposed framework also resulted in a lower metabolic cost compared to the CMA-ES method [11]. The faster optimization may have contributed to identifying better personalized assistance as it could minimize long optimization-induced fatigue.

The robotic prosthesis' personalized and generic condition had higher metabolic costs than their prescribed, customary prosthesis for Subject 2. One possible reason could be the relatively larger size and weight of the AFP. The AFP was designed for a male subject with foot size 10, while the prescribed prosthesis was smaller, with size 9 for a female user. This difference between the prescribed prosthesis and the robotic AFP could have affected the participants' gait kinematics and led to changes in metabolic cost [59]. In addition, the participants with transtibial amputation had limited time to learn the robotic AFP use (1-2 hours), compared to their years of experience with their own prosthesis (Subject 1:17 years, Subject 2:23 years). Our recent study suggests that implementing a user training protocol can facilitate a faster learning process for device use, leading to a reduction in metabolic cost when walking with the wearable robot [40]. Future work should consider including such user guidance protocols in this framework to aid user adaptation to the wearable robot.

Case study 2. Speed-specific personalized assistance: The personalized assistance using this framework was found to reduce the metabolic cost by an average of 7.8% under speed-specific conditions compared to the generic assistance condition, indicating that this framework can be applied to various walking speeds. Furthermore, the optimization process took only 12 minutes, which is one-third of the time required by state-of-the-art methods for three different walking speeds. Recent studies have emphasized the importance of personalized assistance in natural settings, and these fast and adaptable optimization results could be useful for providing personalized assistance in the outdoor environment [5], [19].

Case study 3. Step frequency optimization: The personalization and modular framework successfully identified optimal frequency through the use of different cost function modules and BO modules. Especially when an ECG-based cost estimation module was used, the optimal step frequency was identified 43% faster than a respiratory-based cost estimation method, including PPE. Also, regardless of the BO module variants on the parameter selection method, the optimal point was found in 5 iterations. The ECG-based cost estimation also has additional advantages in terms of portability and wearer comfort, making it a desirable alternative to indirect calorimetry, which relies on face masks, and it may help to optimize assistance in a natural setting.

The framework described in these case examples was developed using a BO. Although BO has been successfully used to personalize assistance in a short time [16], [20], it has a limitation in accounting for a time-varying response to prolonged exoskeleton usage [60], [61]. Additional versions of this framework can include optimization algorithms to address time-varying dynamics, such as time-dependent BO algorithms [62].

A limitation of this proposed framework is that the machine in a human-machine system should operate based on a pre-determined parameter set, influencing human-machine system outcomes. For a wearable robot case, it is typically a parameterized trajectory and a relevant controller. To make this framework more accessible, an open and primitive controller can be included.

### V. Conclusion

In this study, we developed a personalization framework for wearable devices, comprising a human-machine system, cost function estimation, and Bayesian optimization. The framework is designed to be both modular and versatile. By keeping the optimization algorithm constant while allowing for easy integration of different cost functions, this framework could help benchmark exoskeleton performance and personalize wearable robots for various populations. Additionally, the modular configuration of the framework allows for expansion and the ability to test multiple optimizations simultaneously in parallel. The results from case studies demonstrate that the framework is applicable for multiple populations, assistive devices, cost functions, and optimization setups. Overall, this framework has the potential to lower the barrier of entry for personalizing wearable robots and help further advance their performance.

We tested this framework in three case studies involving diverse subjects and wearable robots. The first case study focused on personalizing an ankle-foot prosthesis using indirect calorimetry feedback. This resulted in a 5.3% and 18.1% reduction in metabolic cost for walking for two individuals with transtibial amputation, compared to the weight-based assistance. The second case study personalized a robotic ankle exoskeleton for three different walking speeds using indirect calorimetry feedback for two subjects. The metabolic cost was reduced by 1%, 2%, and 5.8% for one subject and by 20.8%, 1.9%, and 19% for the other subject, compared to a generic assistance condition for increasing speeds. The third case study personalized gait parameters, specifically step frequency, using an electrocardiogram (ECG)-based cost function along with an optimization algorithm variant, resulting in a 43% reduction in optimization time for one able-bodied subject. These case studies suggest that our personalization framework can effectively personalize wearable robot parameters and potentially enhance assistance benefits.

### Example 2

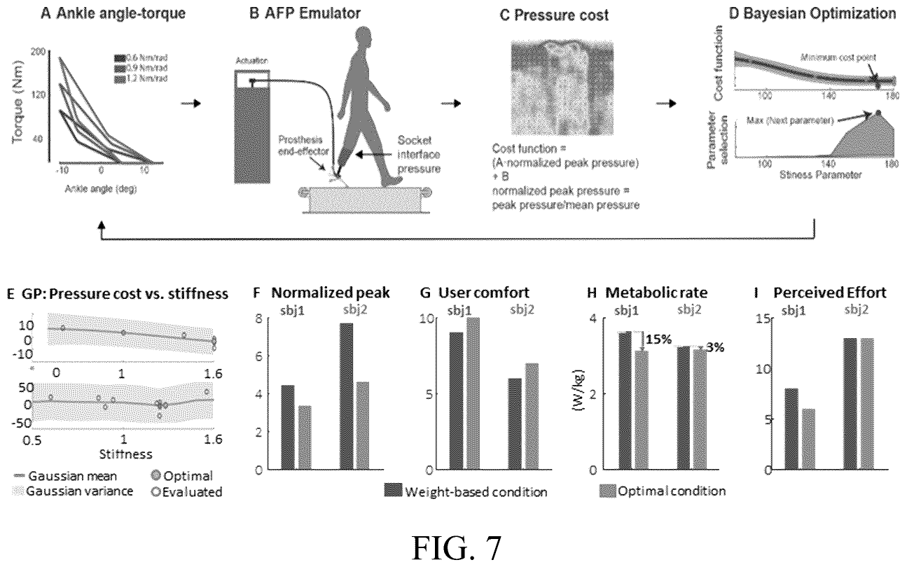

Referring to FIG. 7, results of exemplary human-in-loop optimization methods are shown.

Methods: We conducted a pilot study to investigate the effect of AFP plantarflexion stiffness on residuum-socket interface pressure and user comfort in persons with unilateral TTA. We also examined the effect of personalized AFP stiffness to minimize interface pressure, maximize comfort, and minimize walking effort. The personalized stiffness solution was achieved through human-in-the-loop (HIL) Bayesian optimization of a stiffness parameter using our robotic AFP emulator (FIG. 7 at (A-D)). Our cost function was dependent on socket interface pressure. This intervention on the pressure-based HIL optimization process has been disclosed. Two participants with TTA experienced three days of an experimental protocol. We measured instantaneous residuum-socket interface pressure, Socket Comfort Score, Borg perceived exertion scale, and the metabolic cost of walking. We used the final day's data for data analysis.

Results: The AFP stiffness influenced socket interface pressures, and the HIL stiffness parameter optimization converged on an optimal parameter (FIG. 7 at (E)). The personalized stiffness in the AFP emulator reduced normalized peak pressure, increased user comfort, and reduced metabolic rate compared to a body mass-weighted stiffness for both participants (FIG. 7 at (F-H)). One participant also reported reduced perceived effort (FIG. 7 at (I)).

Discussion: Our preliminary results suggest that AFP stiffness can influence residuum-socket interface pressure and user comfort. The outcome also suggests that personalized foot stiffness can effectively reduce the residuum-socket interface pressure, reduce walking effort, and improve user comfort for persons with unilateral TTA. As this HIL Bayesian optimization aims to improve user comfort by directly employing pressure feedback as a cost function, this optimization scheme could have direct clinical application. Future work includes a rigorous evaluation of the effect of personalized stiffness on user comfort and walking effort.

### Example 3

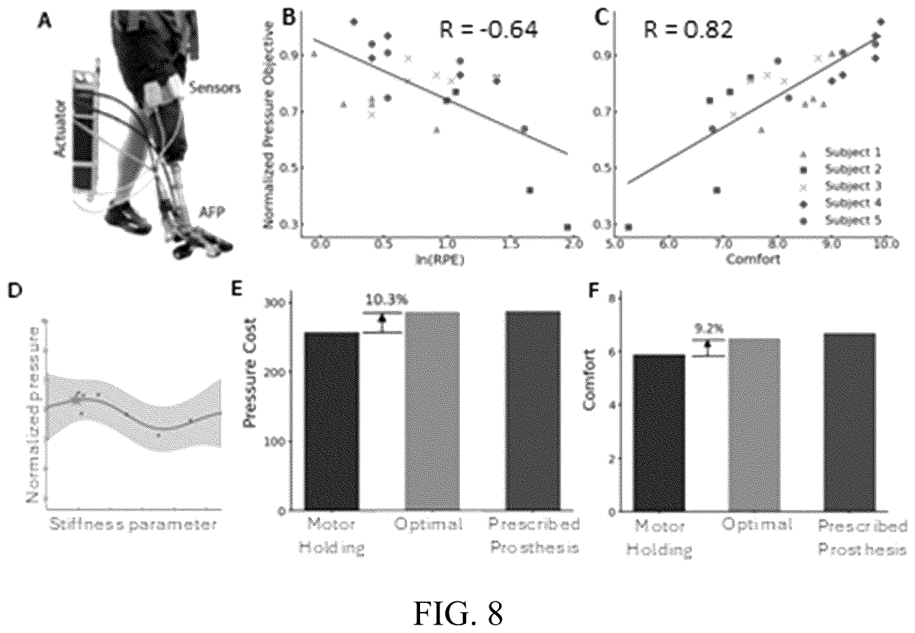

Referring to FIG. 8, results of exemplary human-in-loop optimization methods are shown.

Subjects: Three persons with unilateral transtibial amputation without known medical conditions other than amputation.

Apparatus: Pressure sensors (Tekscan, US) were attached to the lateral and anterior walls of the customary socket to measure instantaneous interface pressure. The objective function estimated pressure cost defined as the sum of the pressure over the entire trial divided by the peak pressure. Given a set of the observed data over time while walking with the AFP, the HIL BO algorithm optimizes a function (Gaussian process) to select new parameter values. A maximum value of the ‘pressure cost’ is then selected as the optimal parameter (AFP keel stiffness).

Procedures: Participants walked at a self-selected speed on a treadmill with a robotic AFP (FIG. 8 at (A)), which permits rapid changes in AFP keel stiffness, attached to their customary socket. On Visit 1, they walked with 5 discrete AFP keel stiffness values for 2 minutes. After each trial, they scored their socket comfort (0-10 via a visual analogue scale) and rate of perceived effort (RPE). The pressure cost was calculated and its association with comfort and RPE were assessed with estimates of Pearson's Correlation coefficient. On Visit 2, HIL BO was performed during 4 minutes of walking using the pressure objective function to identify the optimized AFP stiffness which maximized the pressure cost outcome. Cost and socket comfort were recorded while participants walked with the HIL optimized robotic AFP stiffness, a fixed robotic AFP stiffness reflecting a typical dynamic response AFP, and their customary (prescribed) AFP.

### RESULTS

The normalized pressure cost was strongly correlated (FIG. 8 at (B-C)) with socket comfort (r=0.75) and log-transformed RPE (r=−0.67). The HIL BO algorithm successfully converged onto an optimized AFP stiffness for each participant, increasing the pressure cost and user comfort by 10% and 9%, respectively, compared to the fixed stiffness setting and approached levels similar to the participants' customary AFP.

### DISCUSSION

These results suggest that residuum-socket interface pressures share a direct relationship with socket comfort and effort during walking. These pressures can be input into an objective function that through a HIL BO algorithm can effectively identify a personalized AFP stiffness to maximize perceived socket comfort.

### CONCLUSION

Residuum-socket interface pressure offers a useful measurement to optimize AFP mechanical function to maximize socket comfort, supporting mobility and user satisfaction.

### Example 4

Methods: Three persons with unilateral transtibial amputation (2 male, 1 female, 47.7±8.9 yrs, 80.5±17.7 kg) participated in this study. Pressure sensors (model 9811E, Tekscan, US) were fixed to the lateral and anterior walls of the socket, which commonly reflect pressure intolerant zones and can provide information on user discomfort. Each subject walked at a self-selected comfortable pace on a treadmill while wearing a robotic AFP that permits rapid adjustments in ankle-foot stiffness. Participants experienced walking for two minutes with five discrete AFP (keel) stiffness values of increasing stiffness spanning a range of commercial stiffness values. After each 2 min of walking, the subjects were asked about their socket comfort and level of exertion using the Socket Comfort score and Rate of Perceived Exertion (RPE)³, respectively. In post-processing, the measured residuum-socket interface pressures were used to calculate the ‘Pressure Objective’, defined as the sum of the pressure over the entire trial divided by the peak pressure. To evaluate the relationship of the ‘Pressure Objective’ against comfort and effort, we estimated the Pearson's Correlation coefficient between each variable set.

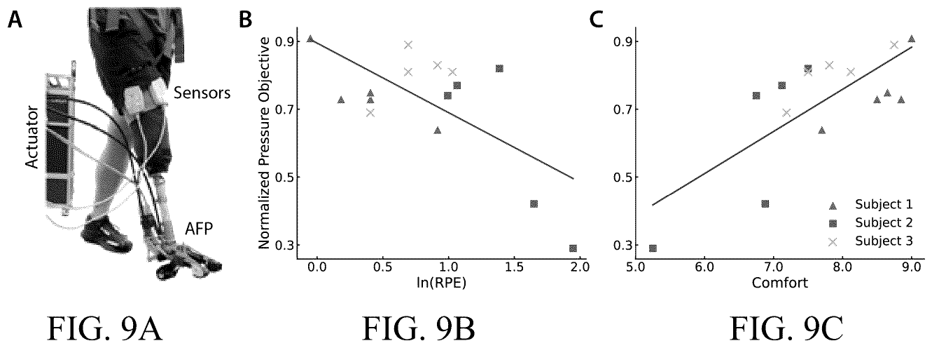

Results & Discussion: FIG. 9B displays the Pressure Objective data versus comfort and log-transformed RPE, as well as the linear best fit line and Pearson's Correlation coefficient for both the ln (RPE) (r=−0.67) and comfort (r=0.75) against the ‘Pressure Objective’. These preliminary results suggest that a decrease in residuum-socket interface is associated with increased socket comfort and reduced walking effort. In other words, a reduction in socket pressure may be directly linked to a transtibial prosthesis user's experience of how comfortable their socket is to walk with and the perceived amount of exertion needed to ambulate. These findings have important clinical implications as small changes in prosthetic ankle-foot stiffness could impact user perceptions that influence their mobility and quality of life, as well as offer set objectives for ‘smart’ prostheses to achieve for maintaining high levels of prosthesis user experience.

Significance: Our findings contribute to understanding the relationship between residuum socket-interface pressures and the perceived comfort and exertion of transtibial prosthesis users. Knowledge gained from systematic studies of this type can also offer a paradigm shift towards patient-centered and data-driven wearable robot assistance. Importantly, this objective function can be used to personalize AFP stiffness through the human-in-the-loop optimization framework. Overall, our study's outcomes have the potential to help inform prescription guidelines of AFP stiffness if the clinical aim is to maximize user comfort during walking.

The following references of Examples 1-4 are incorporated by reference herein in their respective entireties:
[1] P. Kantharaju, H. Jeong, S. Ramadurai, M. Jacobson, H. Jeong, and M. Kim, “Reducing Squat Physical Effort Using Personalized Assistance From an Ankle Exoskeleton,” IEEE Trans. Neural Syst. Rehabil. Eng., vol. 30, pp. 1786-1795, 2022, doi: 10.1109/TNSRE.2022.3186692.
[2] M. Jacobson et al., “Foot contact forces can be used to personalize a wearable robot during human walking,” Sci. Rep., vol. 12, no. 1, Art. no. 1, June 2022, doi: 10.1038/s41598-022-14776-9.
[3] J. Zhang et al., “Human-in-the-loop optimization of exoskeleton assistance during walking,” Science, vol. 356, no. 6344, pp. 1280-1284 June 2017, doi: 10.1126/science.aal5054.
[4] K. A. Witte, P. Fiers, A. L. Sheets-Singer, and S. H. Collins, “Improving the energy economy of human running with powered and unpowered ankle exoskeleton assistance,” Sci. Robot., vol. 5, no. 40, p. eaay9108, March 2020, doi: 10.1126/scirobotics.aay9108.
[5] P. Slade, M. J. Kochenderfer, S. L. Delp, and S. H. Collins, “Personalizing exoskeleton assistance while walking in the real world,” Nature, vol. 610, no. 7931, Art. no. 7931 October 2022, doi: 10.1038/s41586-022-05191-1.
[6] M. Kim and S. H. Collins, “Once-Per-Step Control of Ankle Push-Off Work Improves Balance in a Three-Dimensional Simulation of Bipedal Walking,” IEEE Trans. Robot., vol. 33, no. 2, pp. 406-418, April 2017, doi: 10.1109/TRO.2016.2636297.
[7] M. Kim et al., “Visual guidance can help with the use of a robotic exoskeleton during human walking (in review),” Sci. Rep. Rev.
[8] “Walking Faster and Farther With a Soft Robotic Exosuit: Implications for Post-Stroke Gait Assistance and Rehabilitation,” IEEE Open J. Eng. Med. Biol., vol. 1, pp. 108-115, April 2020, doi: 10.1109/OJEMB.2020.2984429.
[9] J. Vaughan-Graham, D. Brooks, L. Rose, G. Nejat, J. Pons, and K. Patterson, “Exoskeleton use in post-stroke gait rehabilitation: a qualitative study of the perspectives of persons post-stroke and physiotherapists,” J. Neuroengineering Rehabil., vol. 17, no. 1, p. 123, September 2020, doi: 10.1186/s12984-020-00750-x.
[10] R. E. Quesada, J. M. Caputo, and S. H. Collins, “Increasing ankle push-off work with a powered prosthesis does not necessarily reduce metabolic rate for transtibial amputees,” J. Biomech., vol. 49, no. 14, pp. 3452-3459 October 2016, doi: 10.1016/j.jbiomech.2016.09.015.
[11] C. G. Welker, A. S. Voloshina, V. L. Chiu, and S. H. Collins, “Shortcomings of human-in-the-loop optimization of an ankle-foot prosthesis emulator: a case series,” R. Soc. Open Sci., vol. 8, no. 5, p. 202020, doi: 10.1098/rsos.202020.
[12] R. W. Nuckols, K. Z. Takahashi, D. J. Farris, S. Mizrachi, R. Riemer, and G. S. Sawicki, “Mechanics of walking and running up and downhill: A joint-level perspective to guide design of lower-limb exoskeletons,” PLOS ONE, vol. 15, no. 8, p. e0231996, August 2020, doi: 10.1371/journal.pone.0231996.
[13] N. Stergiou, R. T. Harbourne, and J. T. Cavanaugh, “Optimal Movement Variability: A New Theoretical Perspective for Neurologic Physical Therapy,” J. Neurol. Phys. Ther., vol. 30, no. 3, pp. 120-129, September 2006, doi: 10.1097/01.NPT.0000281949.48193.d9.
[14] P. Antonellis, S. Galle, D. D. Clercq, and P. Malcolm, “Altering gait variability with an ankle exoskeleton,” PLOS ONE, vol. 13, no. 10, p. e0205088, October 2018, doi: 10.1371/journal.pone.0205088.
[15] Y. Ding, M. Kim, S. Kuindersma, and C. J. Walsh, “Human-in-the-loop optimization of hip assistance with a soft exosuit during walking,” Sci. Robot., vol. 3, no. 15, pp. 1-9, 2018, doi: 10.1126/scirobotics.aar5438.
[16] M. Kim et al., “Bayesian Optimization of Soft Exosuits Using a Metabolic Estimator Stopping Process,” Aug. 2019, pp. 9173-9179. doi: 10.1109/icra.2019.8793817.
[17] J. Koller, D. Gates, D. Ferris, and C. Remy, “Body-in-the-Loop” Optimization of Assistive Robotic Devices: A Validation Study. 2016. doi: 10.15607/RSS.2016.XII.007.
[18] W. Felt, J. C. Selinger, J. M. Donelan, and C. D. Remy, “'Body-in-the-loop': Optimizing device parameters using measures of instantaneous energetic cost,” PLOS ONE, vol. 10, no. 8, pp. 1-21, August 2015, doi: 10.1371/journal.pone.0135342.
[19] G. M. Bryan et al., “Optimized hip-knee-ankle exoskeleton assistance at a range of walking speeds,” Bioengineering, preprint, March 2021. doi: 10.1101/2021.03.26.437212.
[20] M. Kim et al., “Human-in-the-loop Bayesian optimization of wearable device parameters,” PLOS ONE, vol. 12, no. 9, pp. 6-8, September 2017, doi: 10.1371/journal.pone.0184054.
[21] P. W. Franks, G. M. Bryan, R. Reyes, M. P. O'Donovan, K. N. Gregorczyk, and S. H. Collins, “The Effects of Incline Level on Optimized Lower-Limb Exoskeleton Assistance,” Bioengineering, preprint, September 2021. doi: 10.1101/2021.09.13.460170.
[22] T.-C. Wen, M. Jacobson, X. Zhou, H.-J. Chung, and M. Kim, “The personalization of stiffness for an ankle-foot prosthesis emulator using Human-in-the-loop optimization,” in 2020 IEEE/RSJ International Conference on Intelligent Robots and Systems (IROS), October 2020, pp. 3431-3436. doi: 10.1109/IROS45743.2020.9341101.
[23] P. Kantharaju and M. Kim, “Phase-Plane Based Model-Free Estimation of Steady-State Metabolic Cost,” IEEE Access, vol. 10, pp. 97642-97650, 2022, doi: 10.1109/ACCESS.2022.3205629.
[24] D. M. Blei and M. I. Jordan, “Variational inference for Dirichlet process mixtures,” Bayesian Anal., vol. 1, no. 1, pp. 121-143, March 2006, doi: 10.1214/06-BA104.
[25] N. Nasios and A. G. Bors, “Blind source separation using variational expectation-maximization algorithm,” in International Conference on Computer Analysis of Images and Patterns, 2003, pp. 442-450.
[26] N. Nasios and A. G. Bors, “Variational learning for Gaussian mixture models,” IEEE Trans. Syst. Man Cybern. Part B Cybern., vol. 36, no. 4, pp. 849-862, August 2006, doi: 10.1109/TSMCB.2006.872273.
[27] H. Han et al., “Selection of Muscle-Activity-Based Cost Function in Human-in-the-Loop Optimization of Multi-Gait Ankle Exoskeleton Assistance,” IEEE Trans. Neural Syst. Rehabil. Eng., vol. 29, pp. 944-952, 2021, doi: 10.1109/TNSRE.2021.3082198.
[28] H. Jeong, P. Haghighat, P. Kantharaju, M. Jacobson, H. Jeong, and M. Kim, “Muscle coordination and recruitment during squat assistance using a robotic ankle-foot exoskeleton,” Sci. Rep., vol. 13, no. 1, Art. no. 1, January 2023, doi: 10.1038/s41598-023-28229-4.
[29] K. A. Ingraham, C. D. Remy, and E. J. Rouse, “The role of user preference in the customized control of robotic exoskeletons,” Sci. Robot., vol. 7, no. 64, p. eabj3487, March 2022, doi: 10.1126/scirobotics.abj3487.
[30] S. Michael, K. S. Graham, and G. M. Davis, “Cardiac Autonomic Responses during Exercise and Post-exercise Recovery Using Heart Rate Variability and Systolic Time Intervals—A Review,” Front. Physiol., vol. 8, p. 301, May 2017, doi: 10.3389/fphys.2017.00301.
[31] M. P. Tulppo, T. H. Makikallio, T. E. Takala, T. Seppanen, and H. V. Huikuri, “Quantitative beat-to-beat analysis of heart rate dynamics during exercise,” Am. J. Physiol.—Heart Circ. Physiol., vol. 271, no. 1, pp. H244-H252, July 1996, doi: 10.1152/ajpheart. 1996.271.1.H244.
[32] L. Mourot, M. Bouhaddi, S. Perrey, J.-D. Rouillon, and J. Regnard, “Quantitative Poincaré plot analysis of heart rate variability: effect of endurance training,” Eur. J. Appl. Physiol., vol. 91, no. 1, pp. 79-87, January 2004, doi: 10.1007/s00421-003-0917-0.
[33] F. Shaffer and J. P. Ginsberg, “An Overview of Heart Rate Variability Metrics and Norms,” Front. Public Health, vol. 5, 2017, doi: 10.3389/fpubh.2017.00258.
[34] A. B. Ciccone, J. A. Siedlik, J. M. Wecht, J. A. Deckert, N. D. Nguyen, and J. P. Weir, “Reminder: RMSSD and SD1 are identical heart rate variability metrics,” Muscle Nerve, vol. 56, no. 4, pp. 674-678, October 2017, doi: 10.1002/mus.25573.
[35] C. Povea, L. Schmitt, J. Brugniaux, G. Nicolet, J.-P. Richalet, and J.-P. Fouillot, “Effects of Intermittent Hypoxia on Heart Rate Variability during Rest and Exercise,” High Alt. Med. Biol., vol. 6, no. 3, pp. 215-225, September 2005, doi: 10.1089/ham.2005.6.215.
[36] A. S. Leicht, W. H. Sinclair, and W. L. Spinks, “Effect of exercise mode on heart rate variability during steady state exercise,” Eur. J. Appl. Physiol., vol. 102, no. 2, pp. 195-204, January 2008, doi: 10.1007/s00421-007-0574-9.
[37] I. Garcia-Tabar, L. Sánchez-Medina, J. F. Aramendi, M. Ruesta, J. Ibañez, and E. Gorostiaga, “Heart rate variability thresholds predict lactate thresholds in professional world-class road cyclists,” J. Exerc. Physiol. Online, vol. 16, pp. 38-50, January 2013.
[38] P. Slade, R. Troutman, M. J. Kochenderfer, S. H. Collins, and S. L. Delp, “Rapid energy expenditure estimation for ankle assisted and inclined loaded walking,” J. NeuroEngineering Rehabil., vol. 16, pp. 67-67, 2019, doi: 10.1186/s12984-019-0535-7.
[39] J. C. Selinger and J. M. Donelan, “Estimating instantaneous energetic cost during non-steady-state gait,” J. Appl. Physiol., vol. 117, no. 11, pp. 1406-1415 December 2014, doi: 10.1152/japplphysiol.00445.2014.
[40] M. Kim, H. Lyness, T. Chen, and S. H. Collins, “The Effects of Prosthesis Inversion/Eversion Stiffness on Balance-Related Variability During Level Walking: A Pilot Study,” J. Biomech. Eng., vol. 142, no. 9, p. 091011, September 2020, doi: 10.1115/1.4046881.
[41] J. Kim et al., “Soft wearable flexible bioelectronics integrated with an ankle-foot exoskeleton for estimation of metabolic costs and physical effort,” Npj Flex. Electron., vol. 7, no. 1, Art. no. 1, January 2023, doi: 10.1038/s41528-023-00239-2.
[42] B. J. Whipp, “Dynamics of pulmonary gas exchange,” Circulation, vol. 76, no. 6 Pt 2, pp. VI18-28, December 1987.
[43] J. M. Brockway, “Derivation of formulae used to calculate energy expenditure in man,” Hum. Nutr. Clin. Nutr., vol. 41, no. 6, pp. 463-471, November 1987.
[44] H. G. Sung, “Gaussian mixture regression and classification,” PHD Thesis, 2004.
[45] P. Hamilton, “Open source ECG analysis,” in Computers in Cardiology, September 2002, pp. 101-104. doi: 10.1109/CIC.2002.1166717.
[46] V. Kalidas and L. Tamil, “Real-time QRS detector using stationary wavelet transform for automated ECG analysis,” in 2017 IEEE 17th International Conference on Bioinformatics and Bioengineering (BIBE), 2017, pp. 457-461.

[47] D. Makowski et al., “NeuroKit2: A Python toolbox for neurophysiological signal processing,” Behav. Res. Methods, vol. 53, no. 4, pp. 1689-1696 February 2021, doi: 10.3758/s13428-020-01516-y.
[48] H. J. Baek, C.-H. Cho, J. Cho, and J.-M. Woo, “Reliability of Ultra-Short-Term Analysis as a Surrogate of Standard 5-Min Analysis of Heart Rate Variability,” Telemed. E-Health, vol. 21, no. 5, pp. 404-414, March 2015, doi: 10.1089/tmj.2014.0104.
[49] R. O. Robinson, W. Herzog, and B. M. Nigg, “Use of force platform variables to quantify the effects of chiropractic manipulation on gait symmetry,” J. Manipulative Physiol. Ther., vol. 10, no. 4, pp. 172-176, August 1987.
[50] J. Snoek, H. Larochelle, and R. P. Adams, “Practical bayesian optimization of machine learning algorithms,” Adv. Neural Inf. Process. Syst., vol. 25, 2012.
[51] M. Pelikan, D. E. Goldberg, and E. Cantú-Paz, “BOA: The Bayesian Optimization Algorithm.” [Online]. Available: http://medal-lab.org/hboa/boa.pdf
[52] E. Schulz, M. Speekenbrink, and A. Krause, “A tutorial on Gaussian process regression: Modelling, exploring, and exploiting functions,” J. Math. Psychol., vol. 85, pp. 1-16, August 2018, doi: 10.1016/j.jmp.2018.03.001.
[53] C. K. Williams and C. E. Rasmussen, Gaussian processes for machine learning, vol. 2. MIT press Cambridge, MA, 2006.
[54] P. I. Frazier, “A tutorial on Bayesian optimization,” ArXiv Prepr. ArXiv180702811, 2018.
[55] M. Balandat et al., “BoTorch: A Framework for Efficient Monte-Carlo Bayesian Optimization,” in Advances in Neural Information Processing Systems, 2020, vol. 33, pp. 21524-21538. Accessed: Feb. 8, 2023. [Online]. Available: https://proceedings.neurips.cc/paper/2020/hash/f5b1b89d98b7286673128a5fb112cb9a-Abstract.html
[56 ] R. Benassi, J. Bect, and E. Vazquez, “Bayesian Optimization Using Sequential Monte Carlo,” in Learning and Intelligent Optimization, Berlin, Heidelberg, 2012, pp. 339-342. doi: 10.1007/978-3-642-34413-8_24.
[57] R. S. Hanspal, K. Fisher, and R. Nieveen, “Prosthetic socket fit comfort score,” Disabil. Rehabil., vol. 25, no. 22, pp. 1278-1280 November 2003, doi: 10.1080/09638280310001603983.
[58] D. J. Farris and G. S. Sawicki, “The mechanics and energetics of human walking and running: a joint level perspective,” J. R. Soc. Interface, vol. 9, no. 66, pp. 110-118, January 2012, doi: 10.1098/rsif.2011.0182.
[59] C. A. Zirker, B. C. Bennett, and M. F. Abel, “Changes in kinematics, metabolic cost and external work during walking with a forward assistive force,” J. Appl. Biomech., vol. 29, no. 4, pp. 481-489, August 2013, doi: 10.1123/jab.29.4.481.
[60] K. L. Poggensee and S. H. Collins, “How adaptation, training, and customization contribute to benefits from exoskeleton assistance,” Neuroscience, preprint, April 2021. doi: 10.1101/2021.04.25.440289.
[61] S. N. Simha, J. D. Wong, J. C. Selinger, S. J. Abram, and J. M. Donelan, “Increasing the gradient of energetic cost does not initiate adaptation in human walking,” J. Neurophysiol., vol. 126, no. 2, pp. 440-450, August 2021, doi: 10.1152/jn.00311.2020.
[62] X. Zhou and N. Shroff, “No-Regret Algorithms for Time-Varying Bayesian Optimization,” in 2021 55th Annual Conference on Information Sciences and Systems (CISS), Baltimore, MD, USA, March 2021, pp. 1-6. doi: 10.1109/CISS50987.2021.9400292.

### Example 5: Framework for Personalizing Wearable Devices Using Real-Time Physiological Measures

### Kernel Functions

In the framework, we are using GPU-accelerated Gaussian processing library (GPytorch) [1] and BO-torch a GPU-accelerated Bayesian optimization toolkit [2].

### 1.1 Radial Basis Function

The Radial basis function is one of the foundation kernels used in the Gaussian process posterior function [3]. The function is represented as follows. Here ∥x−x′∥2 is the Euclidean distance between the input parameters x, x. The σ is the free parameter, which is generally optimized during the regression by maximizing the log-likelihood of the regression output.

$$K ( x , {x}^{′} ) = exp ( - \frac{{‖ x , {x}^{′} ‖}^{2}}{2 {σ}^{2}} )$$

### 1.2 Squared Exponential Kernel

The Squared-Exponential (SE) kernel is one of the famous RBF-based kernels with infinitely many basis points. The kernel is defined as shown in the below equation, given the two input vectors x, x′. The kernel's hyper-parameters are σ and 1. These hyper-parameters and the noise parameters are optimized by maximizing the log-likelihood of the Gaussian Process estimate.

$${k}_{SE} ( x , {x}^{′} ) = {σ}^{2} exp ( - \frac{{‖ x , {x}^{′} ‖}^{2}}{2 \cdot l} )$$

### 1.3 Matern Kernel

The Matern Kernel is another famous derivative of the RBF kernel. The kernel is obtained through the Fourier transform of the RBF kernel and later applying the student-t function. The matern kernel is generally used in high-dimension applications due to its computational simplicity. The matern kernel is represented in the equation below.

$$k ( x , {x}^{′} ) = \frac{1}{Γ ( γ ) {2}^{γ - 1}} {( \frac{\sqrt{2 γ}}{l} {‖ x , {x}^{′} ‖}^{2} )}^{γ} {K}_{γ} ( \frac{\sqrt{2 γ}}{l} {‖ x - {x}^{′} ‖}^{2} )$$

The Γ is the gamma function, and the K_{γ} is the Bessel function [3].

### 1.4 Rational Quadratic Kernel

The Rational Quadratic (RQ) kernel, similar to the SE kernel results in smooth priors when dealing with Gaussian Processes. It consists of three hyper-parameters σ, α, and l with α always being positive. The RQ kernel converges to the SE kernel with large values of α. Similar to the other kernels, the RQ kernel magnitude increases with the similarity between x and x′. The RQ kernel is represented in the equation below.

$$k ( x , {x}^{′} ) = {{σ}^{2} ( 1 + \frac{{‖ x - {x}^{′} ‖}^{2}}{2 α {l}^{2}} )}^{- α}$$

### 2 Hyper-Parameter Optimization

The parameters of the kernel are commonly known as hyper-parameters. Hyper-parameter optimization aims to fit a better GP to the observed data, thereby decreasing the number of calls to the objective function. Gradient-based optimization (Gradient descent, Adam optimizer) is used to optimize the hyper-parameters with the log marginal likelihood as the loss function. In this framework, we are using Gpytorch to perform the hyperparameter optimization. The loss function is presented as.

$$log ( p ( y \vert X ) = - \frac{1}{2} {y}^{T} {K}^{- 1} y - \frac{1}{2} log \vert K \vert - \frac{n}{2} log ( 2 π )$$

where y is the set of the observed cost, K is the kernel and n is the number of observations made. The hyper-parameters are updated using the below equation

$${θ}_{j} = {θ}_{j} - α \frac{\partial }{\partial {θ}_{j}} J ( θ )$$

where, 9j is are hyper-parameters, α is the learning rate and J(9) is the loss function.

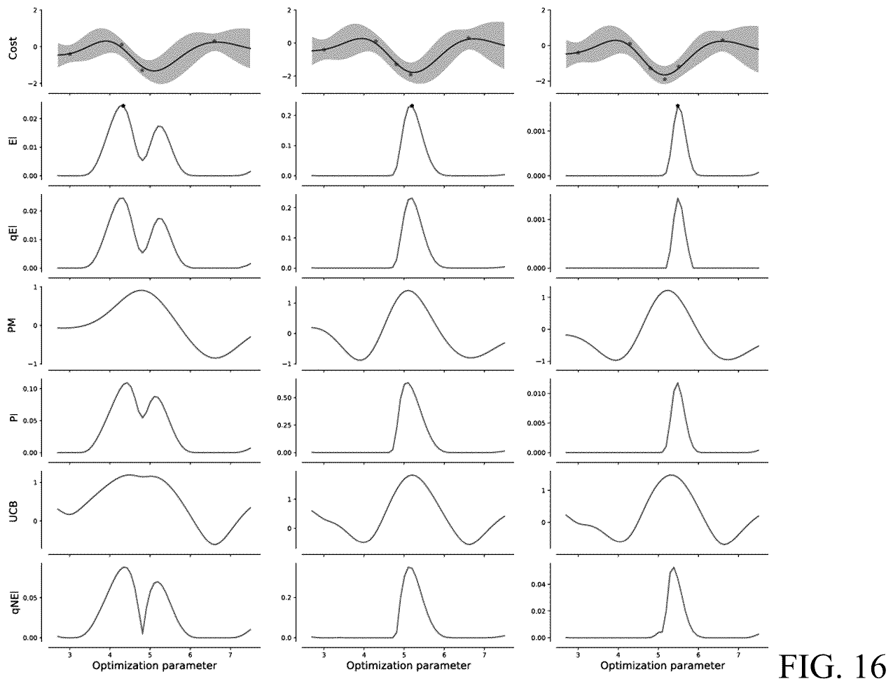

FIG. 16 shows a comparison of different acquisition functions for three 1-dimensional Gaussian process functions. In particular, FIG. 16 shows different acquisition functions for a given posterior distribution.

### 3.1 Posterior Mean

Posterior Mean (PM) is one of the primitive acquisition functions which uses the mean of the model's posterior to estimate the next sampling point. The next sampling point is obtained using the below equation

$${x}_{n + 1} = arg {max}_{{x}_{i} ∈ X} PM ( {x}_{i} )$$

$$where$$

$$PM ( {x}_{i} ) = μ ( {x}_{i} )$$

Due to its simplistic nature, it can be overly dependent on the initial sampling points. Its high dependence on observed space also results in low exploration, making it less popular in Bayesian optimization.

3.2 Upper confidence bound (UCB)

UCB is one of the primitive acquisition functions, which balances the acquisition function's exploration and exploitation. This acquisition function uses the posterior function's mean and standard deviation to estimate the next sampling point. The exploration parameters (γ) required hand tuning, as shown in the equation below.

$$α ( x , γ ) = μ ( x ) + γ \cdot σ ( x )$$

Using the above equation, the next sampling point xn+1 in the parameter space X is assembled as follows.

$${x}_{n + 1} = arg {max}_{{x}_{i} ∈ X} ( α ( {x}_{i} , γ ) )$$

Like PM, this method is highly dependent on the initial observation sampling points of the Bayesian optimization. In addition, due to the dependence on hand tuning and high complexity of the Posterior curve observed in the human in the loop optimization, UCB is generally not considered an ideal function for the optimization.

### 3.3 Probability of Improvement (PI)

This acquisition also uses the mean and standard deviation at each point of the posterior function, with the main idea to maximize the probability of improving the current best estimate f(x_{*}). The formulation of the PI is given as follows.

$$PI ( x ) = Φ ( \frac{μ ( x ) - f ( {x}_{*} )}{σ ( x )} )$$

In the above equation, the φ is the cumulative distribution function obtained using the mean and the standard deviation at that parameter x. The PI is calculated at every point (x) in the parameter space (X) which is then used to calculate the next point, as shown in the following equation.

$${x}_{n + 1} = arg {max}_{{x}_{i} ∈ X} PI ( {x}_{i} )$$

Although this method is an improvement in exploration compared to UCB, the PI method only considered whether sampling points could provide an improvement compared to the point and does not account for the magnitude of the improvement. This method emphasizes exploiting the given posterior function and not exploring other sampling points.

### 3.4 Expectation Improvement

Expectation Improvement (EI) is a popular acquisition function in Bayesian optimization applications. Similar to PI, EI is designed to calculate based on the previous best estimate. However, in this case, EI calculates the Expectation (E) of the improvement over the best function f(x*) shown as follows.

$$EI ( x ) = ( E ) ( I ( x ) ) = {\int }_{- inf}^{inf} I ( x ) φ ( z ) dz$$

Here the q is given as the probability distribution function, and the I(x) is the improvement function, which is obtained by comparing the value at xf(x) and the best-observed value at f(x*).

$$EI ( x ) = ( μ ( x ) - f ( {x}_{*} ) ) \cdot Φ ( \frac{μ - f ( {x}_{*} )}{σ} ) + σ * φ ( \frac{μ - f ( {x}_{*}}{σ} )$$

Similar to the previous acquisition functions, the maximum of the EI calculated in the parameter space is selected as the next sampling point.

$${x}_{n + 1} = arg {max}_{{x}_{i} ∈ X} EI ( {x}_{i} )$$

### 3.5 Monte-Carlo Based Expected Improvement

Monte-Carlo (MC) based acquisition functions are a relatively new form of acquisition functions that use MC sampling to integrate over the posterior distribution. Unlike analytic acquisition functions, MC-based acquisition functions can provide multiple next-best sampling points. MC-based EI or qEI is computed by sampling the joint posterior over q points, followed by computing the improvement over the best-observed value f(x*). This function is maximized over q and then averaged over the number of samples. The qEI takes the below form.

$$qEI ( X ) = \frac{1}{N} ( {\sum }_{i = 1}^{N} {max}_{j = 1 .. q} ( max ( {μ ( X )}_{j} + {( L ( X ) {ϵ}_{i} )}_{j} - f ( {x}_{*} ) , 0 ) )$$

Where μ(X) is the posterior mean, L(X) is the Cholesky decomposition of the posterior covariance and e is a normal distribution with mean 0 and standard deviation 1. Like all previous acquisition functions, the next sampling points are obtained by

$${x}_{n + 1} = arg {max}_{{x}_{i} ∈ {X}^{q}} qEI ( {x}_{i} )$$

### 3.6 Monte-Carlo Based Noisy Expected Improvement

The MC-based Noisy Expected Improvement (qNEI) is similar to qNEI with the exception that it does not assume a known best-observed value f(x*). It samples over the joint posterior function similar to qNEI but computes improvement over all the observed points rather than just f(x*). It takes the form

$$qNEI ( X ) = \frac{1}{N} ( {\sum }_{i = 1}^{N} {max}_{j = 1 .. q} ( max ( {μ ( X )}_{j} + {( L ( X ) {ϵ}_{i} )}_{j} - Y ( X ) , 0 ) )$$

where Y (X) is the set of observed values.

### 5 Case-Study 2 Results

TABLE 1
Speed-specific assistance case study Validation Result

| | | | | | [symbol] | | |
|---|---|---|---|---|---|---|---|
| | | | | | | Rated | |
| | | [symbol] | | | | Perceived | |
| | | Metabolic | Rated | Comfort | Metabolic | effort | Comfort |
| | | cost ( | Perceived | (−10 | cost (W / | ( Borg | (−10 |
| Speed | Condition | [symbol] | [symbol] | [symbol] | kg ) | scale 6 to 20 ) | to 10) |
| 1 m/s | Unpowere [symbol] | 2.51 | 12 | −4 | 2.37 | 14 | 0 |
| | Optimal | 2.39 | 12 | −3 | 2.61 | 15 | 3 |
| | Optimal | 2.25 | 10 | 0 | 2.05 | 12 | 2 |
| | Generic | 2.27 | 12 | −4 | 2.59 | 15 | 3 |
| 1.25 m/s | Unpowere [symbol] | 3.09 | 14 | −5 | 3.05 | 15 | −1 |
| | Optimal | 2.95 | 13 | −4 | 3.00 | 15 | 4 |
| | Optimal | 2.93 | 12 | −2 | 3.06 | 13 | 2 |
| | Generic | 2.99 | 14 | −4 | 3.12 | 13 | 4 |
| 1.5 m/s | Unpowere [symbol] | 3.89 | 16 | −6 | 3.67 | 17 | −2 |
| | Optimal | 3.41 | 15 | −7 | 4.15 | 16 | 4 |
| | Optimal | 3.08 | 13 | −3 | 3.06 | 14 | −1 |
| | Generic | 3.27 | 16 | −3 | 3.78 | 14 | 3 |

[symbol]

indicates data missing or illegible when filed

### Case Study 3

The day 1 data collected for the Case study was used to analyze the time required to estimate the steady state of the RMSSD and the correlation between the Metabolic cost and the ECG measures. As shown in the figure, we saw that there was saturation and steady-state remained consistent after the 60 s, hence we selected the 60 s as the threshold for the estimation time.

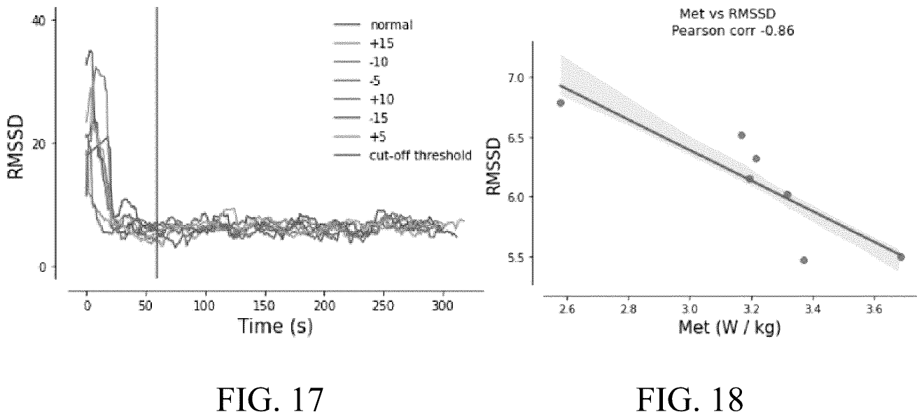

FIG. 17 shows RMSSD for 7 condition observed on day 1 in time-series. The cutoff-threshold presents the 60 s threshold used for the day 2 optimization.

The correlation between the ECG and the metabolic cost for the day one condition is given as follows. Here, RMSSD and metabolic cost had Pearson correlation of 0.86 (FIG. 18). the steady state was measured as the last two minutes' average of the metabolic rate, and the same procedure was used for the RMSSD. FIG. 18 shows a plot of the correlation between the steady state metabolic cost and the RMSSD for the day 1 conditions.

The following references of Example 5 are incorporated by reference herein in their respective entireties:
[1] J. Gardner, G. Pleiss, K. Q. Weinberger, et al., “GPyTorch: Blackbox Matrix-Matrix Gaussian Process Inference with GPU Acceleration,” in Advances in Neural Information Processing Systems, Curran Associates, Inc., 2018.
[2] M. Balandat, B. Karrer, D. R. Jiang, et al., BoTorch: A Framework for Efficient Monte-Carlo Bayesian Optimization, arXiv: 1910.06403 [cs, math, stat], December 2020.
[3] E. Schulz, M. Speekenbrink, and A. Krause, “A tutorial on Gaussian process regression: Modelling,
exploring, and exploiting functions,” en, Journal of Mathematical Psychology, August 2018.
[4] T.-C. Wen, M. Jacobson, X. Zhou, et al., “The personalization of stiffness for an ankle-foot prosthesis emulator using Human-in-the-loop optimization,” in 2020 IEEE/RSJ International Conference on Intelligent Robots and Systems (IROS), ISSN: 2153-0866 October 2020.

Although the foregoing invention has been described in some detail by way of illustration and example for purposes of clarity of understanding, certain changes and modifications may be practiced within the scope of the appended claims.

What is claimed is:

1. A system for customizing a wearable robot, the system comprising:
at least one human parameter measurement device; and
a computing device configured to receive feedback from the at least one human parameter measurement device, wherein the computing device is further configured to communicate with the wearable robot to adjust dynamics of the wearable robot, wherein the computing device comprises at least one processor and memory in communication with the at least one processor, wherein the memory comprises instructions that, when executed by the at least one processor, cause the at least one processor to apply an optimization algorithm to iteratively adjust the dynamics of the wearable robot, wherein each iterative adjustment of the dynamics of the wearable robot by the optimization algorithm comprises:
receiving at least one measurement from the at least one human parameter measurement device; and
adjusting the dynamics of the wearable robot based on the at least one measurement.

2. The system of claim 1, wherein the at least one human parameter measurement device comprises one or more of: an electrocardiogram (ECG), an indirect calorimetry device, a foot contact force sensor, a socket force sensor, a socket pressure sensor, or an input device configured to receive user feedback.

3. The system of claim 1, wherein the optimization algorithm comprises a Bayesian optimization algorithm.

4. The system of claim 3, wherein the Bayesian optimization algorithm comprises:
generating, by the computing device, a posterior distribution; and
selecting, by the computing device, a new parameter associated with the dynamics of the wearable robot.

5. The system of claim 4, wherein the posterior distribution is generated by a Gaussian process.

6. The system of claim 1, wherein the optimization algorithm is configured to optimize based on a particular activity.

7. The system of claim 1, wherein the optimization algorithm is configured to adjust the dynamics of the wearable robot based on the at least one measurement using Expectation of Improvement (EI) and/or a Monte Carlo sampling-based acquisition function.

8. The system of claim 1, further comprising the wearable robot, wherein the wearable robot is an ankle-foot prosthesis.

9. The system of claim 8, wherein the wearable robot comprises a plurality of degrees of freedom, wherein the wearable robot is configured to independently adjust a respective dynamics characteristic about each of the plurality of degrees of freedom.

10. The system of claim 1, wherein the dynamics comprises a torque about a pivotal axis of the wearable robot.

11. The system of claim 1, wherein the dynamics comprises a spring rate.

12. A method for customizing a wearable robot:
receiving at least one measurement from at least one human parameter measurement device while a user performs an activity using the wearable robot; and
applying, by a computing device, an optimization algorithm to iteratively adjust dynamics provided by the wearable robot, wherein each iterative adjustment, by the optimization algorithm, of the dynamics provided by the wearable robot comprises:
receiving, by the computing device, at least one measurement from at least one human parameter measurement device; and
adjusting, by the computing device, the dynamics of the wearable robot based on the at least one measurement.

13. The method of claim 12, wherein the at least one human parameter measurement device comprises one or more of: an electrocardiogram (ECG), an indirect calorimetry device, a foot contact force sensor, a socket pressure sensor, or an input device configured to receive user

14. The method of claim 12, wherein the optimization algorithm comprises a Bayesian optimization algorithm.

15. The method of claim 14, wherein the Bayesian optimization algorithm comprises:
generating, by the computing device, a posterior distribution; and
selecting, by the computing device, a new parameter associated with the dynamics of the wearable robot.

16. The method of claim 14, wherein the posterior distribution is generated by a Gaussian process.

17. The method of claim 14, wherein the optimization algorithm is configured to adjust the dynamics of the wearable robot based on the at least one measurement using Expectation of Improvement (EI) and/or a Monte Carlo sampling-based acquisition function.

18. The method of claim 14, wherein the wearable robot is an ankle-foot prosthesis.

19. The method of claim 14, wherein the wearable robot comprises a plurality of degrees of freedom, wherein the wearable robot is configured to independently adjust a respective dynamics characteristic about each of the plurality of degrees of freedom.

20. A system comprising:
a wearable robot comprising a joint, wherein the wearable robot comprises an actuator configured to provide an adjustable torque about the joint, wherein the wearable robot comprises at least one controller that is configured to:
receive an input from a remote computing device, wherein the input is indicative of an optimization of at least one human parameter measurement associated with a user of the wearable robot; and
set a torque output provided by the actuator, wherein the torque output is selected based on the input received from the remote computing device.
